(19) United States
(12) Patent Application Publication
(10) Pub. No.: US 2013/0346255 A1
(43) Pub. Date: Dec. 26, 2013

(54) Garment Box and System

(71) Applicants: Ben Hayden, Herfordshire (GB); Stephen Brady, Middlesex (GB); Charles Steven Crocker, Plymouth (GB)

(72) Inventors: Ben Hayden, Herfordshire (GB); Stephen Brady, Middlesex (GB); Charles Steven Crocker, Plymouth (GB)

(21) Appl. No.: 13/851,717

(22) Filed: Mar. 27, 2013

(30) Foreign Application Priority Data
Jun. 26, 2012 (GB) 1211462.5
Sep. 7, 2012 (GB) 1215983.6

(51) Int. Cl. B65D 85/18; G06Q 10/08

(52) U.S. Cl. CPC B65D 85/185; G06Q 10/083
USPC 705/27.1; 206/297; 206/279; 53/429; 705/330

(57) ABSTRACT

A garment box is described, the box having a plurality of side wall panels, a ceiling panel and a floor panel, and at least one retainer or a plurality of retainers for securing a garment.

The retainer(s) may be (each) arranged to cooperate with (a respective) one of the panels of the box, for example with respective adjacent panels. A drop and collect cleaning system is also described. A garment to be cleaned is placed in a garment box and the garment box dropped off at a drop off location. The cleaned garment is collected in a garment box from a pre-arranged collection location.

### FIELD OF THE INVENTION

This invention relates to a garment box, a method of folding a garment in a box and a drop and collect cleaning system.

In particularly preferred embodiments, the invention relates to facilitating the ability for the delivery and return of both new and used items of clothing and apparel and the cleaning of such items through an Internet based ordering and fulfilment scheme and use of supply chain solutions, which may include delivery locations (such as shops) or secure locker solutions which are accessible using passwords/keys.

In particularly preferred embodiments, the present invention facilitates a method of folding and packing garments so as to allow their delivery/collection within specified size and volumetric weight restrictions and without creasing.

### BACKGROUND OF THE INVENTION

General containers and garment carrying or packing containers are known in the art. For example, U.S. Pat. Nos. 1,731,996, 2,336,820, 2,508,579, 2,543,275, 3,149,718 and 3,565,242 give examples of such garment containers. These are generally formed from a cardboard blank, folded to form the container. Some have a slim cuboid format and others a more two-dimensional “folder-like” form or appearance.

Each cardboard blank, format has front and back panels, and other parts of the blank fold to couple to these panels, some forming side walls, some forming upper clamping or hood sections. Some provide an integral hanger formed from the blank, others features accommodating an inserted hanger.

U.S. Pat. No. 1,731,996 discloses a strap to hold a garment in a folded position. U.S. Pat. No. 2,543,275 describes a pair of wings which fold over and lock to help prevent a garment moving when in transit. U.S. Pat. No. 2,508,579 has a pair of flaps over which a garment can be draped. U.S. Pat. No. 3,565,242 has a pair of locking flaps to engage a garment.

However, each of these examples is still unable to sufficiently prevent creasing and/or crumpling of the garment when packed. The straps, wings or flaps of the prior art are also insufficient, for example in design and/or strength and/or number, to prevent movement of the garment during transit.

These features of prior art systems are similarly not sufficiently flexible, and do not provide sufficient capabilities or features, to allow different uses of the containers, such as different sizes of garments, or different numbers of the same or different garments.

Furthermore, the aforementioned examples are limited in their capability of alternative use. Those examples with either integrated or separate hangers do not provide sufficient flexibility in the use of such hangers. In addition, in many of the aforementioned examples, a hanger must be used in order to arrange the garment inside the container.

Many of these examples also require external materials to seal the box ready for transportation, which slows down the pick and pack process in fulfilment warehouses, and does not provide flexibility to the pick and pack process. Furthermore external tape also means that once opened, the ability for consumers to return goods at ease using the same packaging is limited. Due to the adhesive tape and staples used, another disadvantage is that the container is not easily recyclable and so cannot easily be disposed of, possibly incurring recycling charges in some jurisdictions.

A yet further disadvantage with the aforementioned examples, which are fitted with a handle, is that the handle often does not have sufficient strength to prevent tearing, for example if heavy items or garments are added to the container.

In addition, the shape of these known garment containers is not conducive to proper management of the garments or cases/pallets containing several packaged garments. In particular the shape of many containers is not compatible with the dimensions of common shipping or freight containers. For example, many mail order and courier services have bespoke package sizes and tariffs.

Online shopping continues to grow with e-commerce sales predicted to reach £963 billion globally by 2013, with an annual growth rate of around 20%. This rapidly expanding global digital community represents a vast potential marketplace for any retail business, with an online presence. E-commerce opens the door to the notion of business without borders—the opportunity to sell products and services to anyone, anywhere in the world.

Developing competitive rich fulfilment services to support e-commerce operations has become more prevalent with operators designing a wide range of logistics competencies ranging from warehouse management, order picking, re-packing and further value-added services right through to aftermarket services such as the management of return logistics. The need to ensure operations are streamlined and automated is becoming ever more important to third party logistic providers, although this is largely unaddressed for packaging of hanging garments such as items of clothing.

Consumers on the whole are turning increasingly to digital channels for greater choice and convenience. New business strategies are emerging as retailers look to merge online services and solutions with traditional ‘bricks and mortar’ stores and retail outlets. The evolution of ‘click and collect’ strategies allows shoppers to enjoy flexibility as well as the benefits of buying online, increasingly without the requirement of having to be at a specific location to facilitate delivery.

In an attempt to reduce costs of so-called ‘final mile’ delivery a cultural shift is towards delivery of items to predefined collection points. Collection points are among a range of new delivery options enabling online retailers to offer last-mile control to their customers at, or close to, the point of purchase. The collection point may be staff-assisted for example ‘over the counter’, such as at a convenience store) or a self-service intelligent locker. Either way, the principle is that it is an efficient, cost-effective way for an online retailer to develop local points-of-presence without having to invest in a network of physical stores. These networks however have a maximum weight and size restriction, often imposed due to space restriction within the location (convenience store) or the restrictions of the locker compartments to ensure easily handling for both the operators and the customers.

Fulfilment of goods remains the biggest inhibitor to the growth of online retailers, as many consumers abandon their online shopping order at the delivery step due to the inconvenience. This can be due to speed of delivery, cost of delivery, quality of goods when they arrive and inconvenience of waiting for deliveries and returning unwanted items.

New propositions for consumers continue to develop to provide value added services to consumers and allow retailers to differentiate themselves in the market. Some companies provide bespoke services for consumers wanting fashion assistance, whereby a fashion stylist selects clothing and apparel based on a consumer's preference to colour, brand, style. Items are sent to the customer, allowing them to try these on in their own home, when it suits them and to return any unwanted goods. The goods that are not returned are charged to the customer's account. Although an innovative business model, delivery and return of multiple goods remains a challenge for retailers and the consumer.

Finding suitable fulfilment options is a challenge, as the quality of the goods when arriving at their final destination to be re-united with their customer is often unknown due to poor packaging options. Furthermore as these goods are very high in value, despite wanting to market their brand, as external branding of packaging, is not recommended as this increases the risk of theft where high value, designer or fashion items are being shipped.

E-Auction sites continue to be popular amongst consumers, especially for the sale/purchase of used garments. However, the buying/selling process remains a challenge, with the seller needing to list an item, usually provide an image of the goods, and once sold, pack and post the goods to the designated address.

On the buyers side, there is increasing need to select a convenient collection point for the delivery address. Failure to do this often risks missing the delivery attempt.

Furthermore as these items of clothing are used, most if not all, purchasers wish to clean these garments prior to wearing. Some items require professional cleaning. More often than not this results in a trip to the dry cleaners, and so adds to end cost of an item and increased delay until the purchaser can wear the garment.

Much emphasis has been placed on solving these problems. However, the convenience of having clothing delivered, and in particular delicate clothing, remains unaddressed. Retailers have to choose to either ship clothing in a hanging garment box, or fold items of clothing into smaller boxes to allow convenient collection points (in order to ensure garments fit in the maximum size restrictions) and so as to be accessible by a large number of consumers. Both these options suffer from drawbacks. Garment hanging boxes result in increased shipping costs due to the overall size and volumetric weight. Furthermore garments can become dislodged from hanging rail during transit. Folding items of clothing to reduce the size of packaging often results in the garments becoming creased. Consumers are left dissatisfied and have the added inconvenience of having to return items of clothing in order to receive a refund, or there is a persistent need to clean and press garments so that they are in a state ready to wear.

Garment recycling is also becoming an important part of many retailers' Corporate Social Responsibility (CSR). Many retailers now promote the return of unwanted or previously used clothing and garments, encouraging customers to drop off clothing at their stores or even to arrange a collection from their home once a garment is no longer required.

The packaging of these items of clothing remains a challenge, as does the ability to access reliable on-line ordering services.

With increased cross boarder selling, customs checks on parcels are becoming increasingly important to confirm that there are no prohibited or restricted goods within the parcel and that the description and value stated on the Customs Declaration is correct. Customs officers sometimes need to examine the contents of a package—particularly when the sender has not completed an official declaration. In such cases opening, inspection, repacking and resealing of the package is carried out, under instruction, by authorised staff. If parcels are opened during transportation there can often be issues that goods are not repacked in the same way; when items of clothing are not repacked, this can lead to damage or creasing taking effect. Furthermore the overall presentation of the parcel is impacted as additional tape (often green) is used to re-seal the parcel and to notify the customers that the parcel has been opened. This can all have a negative impact on the customer experience and the overall selling companies brand.

With the increase in on-line ordering, returns continue to grow. Current estimates are that around 20% of clothing purchased online is returned. This is mainly as a result of customer buying habits, which increasingly are to order a number of different styles and/or sizes, most of which are intended to be returned, which in any event goods are, if they are damaged on delivery.

The full impact of returns on both the consumer and retailer can be significant. For the both the consumer and the retailer, the added inconvenience and frustration are caused from: the need to re-package the items and poor packaging. Sometimes the need to re-package has to be done using the same packaging and tape to secure the goods. Poor repacking of returned goods often results in increased costs when repacking the goods, when they are returned to the retailer. In some instances goods may be damaged and so may have to be written off.

There is often a need to purchase adequate packaging to ensure the safe return of the goods

There is the risk that original packaging supplied by the retailer does meet the requirements of the agreed returns options offered by the retailers. This occurs for example when packaging is larger than the agreed dimensions accepted by a courier operating a returns network.

For the retailer, returns pose a number of direct and indirect costs:

Online returns reduce net revenues, while still burdening the retailer with the original costs associated with inventory, product packaging, and shipment from the manufacturer, and end fulfilment to the consumer.

Additionally, the retailer faces customer service and processing costs for the return itself. When trying to dispose of the returned product through resale or other means, the retailer may have to pay for new packaging as well as moving the product to its ultimate point of disposition.

Indirectly, a defective product, or one that has not been fulfilled properly, may have a negative impact on the retailer's reputation and brand, thus leading customers shunning away from a retailer or bad publicity.

Increasingly environmental implications of returns also needs to be taken into account and is becoming increasingly important, as manufacturers and retailers aim to reduce CO2 emissions and their overall carbon footprint.

It is an object of the invention to provide a solution to resolve these issues, so that retailers can deliver a reliable ‘end-to-end’ customer experience; increase customer satisfaction; and grow online sales, whilst reducing overall costs as well as reduce their environmental footprint.

Laundrette and dry cleaning industries have traditionally operated based on a number of business models:
1. Laundrettes which are manned either during full operating hours or manned partly during operating hours. Customers can use service washes (premium service) or self-service (coin operated) washing machines and dryers.
2. Dry cleaning shops where garments are received from customers, dry cleaned onsite and prepared ready for customer collection at the same location a day or so after drop off. Sometimes other retail outlets acted as agents or receiving/collection points for customers, from where garments were sent to a remote location to be dry cleaned.

There is therefore a continued need for launders and dry cleaners to identify garments and associate them to individual owners/customers. This is becoming more important as the number of items increases and so as to avoid garments getting mixed up or lost during the cleaning process. In many instances paper tickets are assigned to each garment every time they are received. This assignation of labels to each garment was labour intensive and cumbersome for the operator due to the volumes of garments as well as for regular users of these services.

To address the demands posed by the increase in online ordering and booking, many launders and dry cleaners are choosing to extend opening hours and/or develop bespoke online services which include: the ability to place an order and receive (optionally a free) collection and delivery from a customer's preferred location. However, these solutions do not always provide a compelling customer experience and in many cases are not cost effective.

Due to the high labour costs and utility costs, the number of manned laundrettes is reducing. More businesses are looking to introduce coin operated machines (self-service models) to reduce operating costs and increase margins. Although in principle longer opening hours and newer machines sounds appealing, this reduces the convenience and flexibility of many laundrettes. Often a customer needs to remain present or nearby, whilst their garments are being washed as the customer is required to remove garments and place them into a dryer etc. There is also the potential risk of theft when leaving garments unattended.

Many dry cleaners have extended opening hours from, typically 9 am-6 pm or 8 am-8 pm. However, for many people who work, this still does not provide the flexibility to match often demanding and ‘time poor’ lifestyles. Businesses also have the issue that costs rarely outweigh any benefits of opening even longer. Also collection and delivery services have disadvantages, as customers must be in a fixed location in an agreed time window of collection and delivery.

As many customers work this often means having to set aside a day during the weekend. For the operator failed collections/deliveries provide added costs and logistics issues and there is often the need to place a minimum order value for customers so as to make this service sustainable.

Another aim is therefore to provide a flexible service that is available continuously and as and when required by customers. Another objective is to provide a service that is simple and flexible to access remotely.

The present invention aims to address the aforementioned problems and provides improvements upon the known systems.

### SUMMARY OF THE INVENTION

According to a first aspect of the invention there is provided a garment box comprising: a plurality of side wall panels, a ceiling panel and a floor panel; and at least one retainer for securing a garment. Ideally two or more retainers are provided.

Ideally the at least one retainer is arranged to cooperate with one of the panels of the box. More preferably, the plurality of retainers are each arranged to cooperate with a respective panel of the box.

In a particularly preferred embodiment, the plurality of retainers are arranged to cooperate with respective adjacent panels. In another embodiment, the box comprises at least three retainers, each of which is arranged to cooperate with a respective panel.

Features such as these provide the advantage of embodiments of the invention that the load of the garment, inside the box, can be spread further and more efficiently, thereby maintaining the garment in better condition inside the box and more effectively preventing creasing and crumpling.

In addition, the use of more retainers at more points inside the box allows the box to be proportioned more advantageously, for example in a more equally cuboid form, or a standard size for freight, often referred to as volumetric weight.

In another embodiment, the three retainers are each arranged to retain one of three portions of a garment in contact with, or adjacent to, the respective panel, on three adjacent panels of the box.

Preferably, the at least one retainer comprises a planar portion, configured to counteract vertical forces on the garment. More preferably, the at least one retainer is arranged to cooperate with the ceiling panel or the floor panel of the box. Suitably, the planar portion is positionable parallel to the ceiling or floor panel for retaining the garment, thereby counteracting vertical forces on the garment.

Features such as these provide the advantage of embodiments of the invention that vertical loads on the garment retained, are spread over an area of a plane or surface, rather than over a point or line. This provides a more efficient spread of the load and avoids unwanted creasing of the garment and prolongs the life of the box.

Suitably, the at least one retainer is coupled to the panel with which it is arranged to cooperate. Preferably, the at least one retainer is movable between a deployed retaining position and an opened position. More preferably, the at least one retainer is hinged on an edge of the panel.

In another embodiment, the at least one retainer is configurable to retain the garment for securing by trapping the garment between the retainer and the panel with which it is arranged to cooperate.

Preferably the at least one retainer comprises an adjustable retainer. More preferably, the adjustable retainer comprises an adjuster portion for modifying the effective size of the adjustable retainer. Still more preferably, the effective size adjusted is a length of the retainer. Suitably, the effective size adjusted is a volume enclosed by the retainer and the panel with which it is arranged to cooperate. In an advantageous embodiment the retainer comprises a set of two coupled retainer arms extending one towards the other over the panel.

Features such as these provide the advantage of embodiments of the invention that different sizes and amounts of garments can be accommodated by the same retainer, whilst providing the same retaining and load spreading qualities. Thus for example a jacket may be packed with a suitable matching shirt for convenience to the end user.

Preferably, a first retainer arm comprises a set of notches, and a second retainer arm comprises a node for engaging one of the notches to couple the retainer arms, whereby movement of the node from one notch to another, adjusts the effective size of the retainer. An advantage of this is regardless of the garment thickness (thick coat, thin shirt, or multiple goods) the operation can be adjusted to ensure the result is this same.

Suitably, the first retainer arm is hinged to a first edge of the panel, and the second retainer arm is hinged to a second, opposite edge of the panel.

In one particularly preferred embodiment, a retainer is arranged to cooperate with two adjacent panels of the box. Preferably, the first retainer arm is hinged to first edges of each of the two adjacent panels, and the second retainer arm is hinged to second, opposite edges of each of the two adjacent panels. More preferably, the first retainer arm divides into two sub arms in the region of the hinges, a first sub-arm being hinged to the first edge of a first adjacent panel, and a second sub-arm being hinged to the first edge of a second adjacent panel. Suitably, the first retainer arm is folded to cooperate with the fold between the two adjacent panels.

This retainer is ideally whale-fin shaped and has been found to help to protect a retained garment, by trapping air in a liner surrounding the garment, forming an air cushion. This has the particular advantage of improving the crease resilience of the garment during transit.

In an embodiment, the box is a standard size and shape permissible by international logistics networks. The shape of the box enables a reduced overall volumetric weight for shipping goods internationally. This also provides increased convenience as items can be stacked on top of each other in transit.

Suitably, the dimensions of the box are approximately 500 mm by 300 mm by 300 mm or 500 mm by 300 mm by 200 mm. The particular dimensions such as 500 mm by 300 m by 300 mm allow access to the number of ‘final mile’ delivery options including Click & Collect networks, for example.

Another problem solved by the invention relates to airline travel. Increasingly airlines are imposing charges for checking in hold luggage, resulting in extra charges for travellers and in particular business travellers who do not have a suitable alternative for carrying business attire with them. Although smaller ‘carry on’ luggage holders are becoming increasingly popular, in the near future it is likely that airlines may also charge for ‘carry on’ luggage. One preferred feature of the invention is that the box is dimensioned so as to fit in an overhead luggage compartment, thereby providing a convenient sized carrier for business travellers to carry their business attire.

Therefore this embodiment of the invention allows a customer to take a suit on a flight and post it to a dry cleaner, so that it is ready and cleaned by a specific time, for example when the customer return from the business trip. This could also save time and check-in fees on a return leg of a flight.

In another embodiment, an internal portion of the box comprises a fixture for securing smaller garments and/or accessories. For example in this embodiment, the at least one retainer comprises a supporter for holding items within the container, such as a tie or scarf and/or handkerchief and/or undergarments. Preferably, the at least one retainer comprises a retainer according to any of the previously described embodiments, in addition to the supporter.

Suitably, the supporter is a hanger. In one embodiment, the hanger is integral to the box. Optionally at least a portion of the hanger is detachable from the box. Preferably, a border between the detachable portion and the remainder of the hanger is defined by perforations or some other pre-cut weakness. This allows fulfilment of goods without a standard wire or plastic hanger, which increases the environmental benefit.

In another embodiment, the box comprises lockable tabs, the box being closable using the tabs. Preferably, the box further comprises a cut out providing a finger hold for opening the lockable tabs. Suitably, the box further comprises a number of double sided tape, which may be applied during the manufacturing process, so as to facilitate opening and suitable for re-sealing the box one or more times. These features provide ease for the customer, airport security or customs officials, as they can tear open, and also easily re-seal. These features also speed up the pick and pack process, and allow for multiple use of the box.

Ideally the box further comprises a tracking Radio Frequency Identification (RFID) or barcode label, for example for tracking during a workflow process, and/or for logistics and parcel delivery.

The box has an added security feature in that during the manufacturing process, a security mark is placed within allowing for easy identification that the box manufactured is authentic. The cardboard can be ripped and a distinctive label, indicia or other mark is presented so as to be visible.

In another embodiment the ceiling panel comprises a handle portion. Preferably, the ceiling panel comprises strengthening tape, through which perforations are made to form the handle portion. This may also be applied during the manufacturing process. In other embodiments the handle is designed to ensure the box is easy to transport and has extra strength to provide durability. The strengthening tape along the ceiling panel reinforces the handle cut-outs.

The handle design and location also ensures that when the garment(s) is/are folded within the box it remains sealed, and no water or other liquid can access inside a main compartment defined within the box. The handle also allows for the box to convert into a hanging wardrobe box.

Preferably, the box is capable of being folded from a sheet or cardboard blank. In an embodiment, the box further comprises additional panels; the additional panels are foldable into the box on assembly.

Ideally the sheet blank includes panels and ideally comprises one of: a side wall panel; a ceiling panel; and a floor panel. The floor panel has four other panels coupled to four respective edges of said floor panel; and at least one further panel coupled to an outer edge of one of said other panels.

Preferably a furthest panel from said one of the panels has a curved outermost edge, configurable on assembly to straddle a garment that is to be contained by the box upon its assembly.

In a particularly preferred embodiment, in use, the at least one retainer and garment are arranged around the periphery of an internal space of the box defined by the panels, and at least one of the retainers, or a panel, is configured to accommodate an additional garment or item in the internal space or void thereby defined.

This space or void is designed to allow additional items, in order to allow customers to order multiple items (e.g. online) for delivery at the same time. Examples of such additional items may be shoes, an umbrella or other bulky items which are not easily flat and/or foldable.

In another embodiment the box is provided as a flat unfolded article for use as a hanging wardrobe for the garment.

In a further embodiment, the box comprises a detachable portion for use as a hanging wardrobe for the garment. Preferably, the detachable portion comprises a plurality of the aforementioned panels, defining the box, and at least one retainer. More preferably, the box comprises a base portion to which the detachable portion can be attached, the base portion being selected from a plurality of alternative base portions. In one embodiment, the box further comprises a locking mechanism to join the base portion and the detachable portion.

This detachable portion of the box supports automated fulfilment warehouse processes, allowing goods to be part-packed and placed on automated conveyors through a fulfilment or packing plant. Goods can then be finally packed and the appropriate base of the box selected depending on the other items in a customer's order and the number of other items being sent. This also allows flexibility at a pick/pack station and for improved automation in dry cleaning plants and fulfilment warehouses, as goods can be part ‘pick and packed’, but can still proceed through the process whilst the box remains in a part—constructed form.

In one embodiment three distal adjacent panels and associated retainers of the box, are arranged to be foldable into a tri-fold form or element, for assembly into the box. This tri-folding element can be used as part of the hanging wardrobe and is optionally provided in a detachable portion and/or detachable base. The tri-folding element (in certain embodiments and optionally in conjunction with the aforementioned whale-fin feature) is foldable into the assembled box, and then ideally is arranged to self-deploy when the box is hung as a wardrobe.

The tri-fold and whale-fin section can be detached as mentioned above, and as described in greater detail below, for use as a separate wardrobe feature, and as a separate packing part.

According to a second aspect of the invention there is provided a method of folding a garment within a box as described in any of the above embodiments, comprising the steps of: placing the item of clothing on or adjacent an internal surface of the unassembled or part assembled box; placing the at least one retainer in contact with the garment to retain a position without creasing and folding the box along predefined crease lines.

Preferably the method further comprises: folding the box containing the item of clothing into a final assembled box shape or box form. Suitably, the method further comprises placing the garment on a hanger; and securing a hook of the hanger to a fastener of the garment box. In another embodiment of this second aspect, the method further comprises wrapping a tri-fold element of the garment box around a hanging garment, thereby retaining the garment without creasing, and ensuring contents are ready for final assembly and packaging for fulfilment.

The box or container may be used for multiple garments or items including footwear and headwear, such as hats or fascinators. It may also be used for containing other non-clothing goods: such as toys (as part of a children's gift pack): wedding gifts (as part of a wedding outfit); accessories, (for example with a fancy dress garments); or high value items, such as iPads (Trade Mark), tablets or mobile devices, batteries, toiletries or even groceries.

Alternatively, the garment box may receive and store a plurality of garments or other items of clothing. The garment box may have any suitable size or shape for receiving and storing a particular item(s) of clothing to ensure that the garment is not creased. For example, the garment box may be a cardboard box, a case or a bag. The garment box may for example have dimensions of approximately between 300-700 mm×100-500 mm×100-500 mm, ideally substantially 500×300×300 mm.

The garment box preferably provides at least one fastener for receiving and engaging a hook of a hanger for an item of clothing or garment. The fastener may be provided on an internal surface of the garment box and is ideally strengthened by way of a reinforced support that may for example be laminated or embedded within layers of cardboard.

The garment box, for example a cardboard box, is ideally provided as a flat pack so as to be easily stored and transported in readiness for use.

The garment box may provide at least one retaining feature for contacting and retaining the garment in position without creasing. The retaining feature may include any suitable means such as, for example, a flap or an elasticated strap.

The retaining feature is preferably provided on an internal face of the cardboard box, or may be supplied as a separate item or portion within the box. Preferably the retaining feature is adjustable depending upon the number and thickness of garments in the box. This adjustment provides the ability to apply enough pressure to hold the garment(s) in place but not to crease them.

A retainer may, instead of being pre-folded, comprise a mark on the retainer to indicate a position of a fold. The mark can then be scored, and the retainer folded along the score, to provide the fold. A plurality of marks can be provided, so that a variety of different positions of the fold can be used, to provide different allowances for thickness of the garment(s).

Embodiments of the invention also allow garments to be retained and held in place without the need for the garments to be on a traditional garment hanger, as the garments retain their shape by means of the retaining features.

In another preferred embodiment the box includes at least one lockable tab so as to ensure that when the box is folded, to form the garment box, it is securely closed in place, but may be easily opened to retrieve, remove or add garments or items without damaging the box or disturbing its contents.

Ideally the lockable tab comprises a tab on one part of the box that is adapted to be inserted in an aperture on another part of the box. Most preferably a second locking tab is inserted through the first tab so as to secure the box in the closed position. It is envisaged that the first and second tabs may be re-opened and re-sealed more than once.

Typically the tabs are inserted through apertures provided on the box. In preferred embodiments the apertures may include a cut out so as to provide a finger hold thereby allowing the user to remove the tab so as to reopen the box. Ideally these additional tabs are staggered and are formed integrally with the blank of the garment box.

The garment box is ideally a multi-use box as opposed to single use box because it is dimensioned and designed to allow goods to be returned in the same box, for example if the items are not required and need to be returned to the retailer. The garment box can also be used for other purposes such as to return clothing no longer required by consumers who may wish to support garment recycling or charitable programmes. Customers who have purchased goods online, may not wish to return the goods purchased, however may re-use the box as part of a retailers programme to encourage their customer base to recycle unwanted garments. Furthermore as this box can be used a minimum of two times, the box may be re-used for fulfilling clothing sold on Internet auction (e-auction) websites. As the box can be used multiple times and without the need of external materials the garment box can be used by e-auction sellers and buyers.

The overall size and shape of the garment box, along with the design of how the garments are secured inside, has been aimed at providing additional space for other items to be despatched in the same box. For example a pair of shoes, shirt or tie may be despatched in one garment box by utilising the void created once the garments have been accepted into the box and the box folded. This allows retailers to fulfil deliveries of multiple garments and other items to a customer in the garment box (as opposed to different or multiple packaging) saving packaging costs, transportation costs (due to the volumetric pricing on parcels) and reducing their carbon footprint.

The overall size and shape of the garment box allows the box to be delivered or returned using so-called final mile delivery solutions, including parcel shops (convenience stores) and intelligent parcel lockers, because the box has been designed to have specific dimensions of length, width and height in order to fit the maximum size limitations of these networks. The box also fits within hand luggage of airlines.

The garment box may be assembled, ready for despatch, without the requirement for any additional materials (adhesive tapes, bonding materials or staples), therefore saving crucial time and money when packing and despatching goods from a retailer perspective or fulfilment warehouse. This further improves convenience for consumers on returning goods in the same box. The box may have a unique code for each customer so that a packer can scan this as part of the packing process and so as to ensure the garment is being packed in the correct box.

Advantageously the garment box includes a perforated handle which provides extra strength by means of providing more than one layer of material, as there is a strengthening tape through the box, therefore enabling the box to be easily transported by logistics firms' delivery drivers and consumers. This also encourages the correct placement of the box when in transit. This handle is located in such a way to allow easy transportation but to eliminate the risk of water or other liquids entering the compartment where the garment is stored.

As the size and shape of the garment box has been optimised and designed especially to conform with maximum standard dimensions, it allows for business travellers to take a complete set of business garments for a meeting, whether they are travelling by plane or by rail or by automobile. The garment box can be easily carried by commuters or travellers and can easily be stored above seats on trains. It allows travellers to send their goods through a logistics network for example to parcel shops or intelligent lockers based on delivery networks, so that they can collect goods on arrival at a destination or have them delivered to a hotel.

The garment box may also include a plurality of supporting means such as slots, hooks, tabs or loops in order to hold or retain other accessories in place during transportation. These supporting means may vary in length and form so as to accommodate various items such as a standard tie, bow tie or a belt. Likewise pockets or inserts may be provided within the box for receiving smaller items such as cufflinks or tie pins.

The box is optimally supplied in a flat pack form and may be returned to this form when not in use, permitting easy stowage inside, on or behind wardrobes or cupboards. The item of clothing may be placed onto an internal surface of the flat pack garment box wherein the garment box is folded so as to encompass the clothing in situ, for example by suspending the opened box on a wardrobe door or a door hanger.

The garment box may also be supplied with an optional degradable polymer or compostable ‘environmentally friendly’ synthetic plastics cover. The cover may be supplied already affixed to the box or may be placed independently inside. Garments may then be placed in the plastic cover to provide extra security and protection for the goods during transportation.

The garment box maybe provided as a two-piece solution, with a base and a folding element of the box (hereinafter referred to as tri fold or a ‘whale fin’ mechanism) as a separate item. This two-piece solution provides additional flexibility for retailers and fulfilment providers, as they can utilise the garment box as part of their automated pick and pack stations. Furthermore this two-piece solution allows an item of clothing to be placed either onto the internal surface or wrapped around inside a second portion of the box. The final element of the packing can then take place once a full order is known at the packing station: the appropriate base for the garment box can be selected to make a smaller or larger voids for additional items as mentioned above. Optionally the tri-fold and whale fin elements may be used in conjunction with one another so as to ensure that different size or shape boxes are compatible with one another and so as to prevent the boxes from being used with conventional boxes.

According to another aspect of the invention there is provided a user selectable purchase and delivery service, including the steps of: selecting from a menu an article of clothing/footwear; specifying a size for the article of clothing/footwear; specifying a delivery address and providing information sufficient to complete the purchase, whereby the article of clothing/footwear is packaged in a garment box comprising: a plurality of side wall panels, a ceiling panel and a floor panel; and at least one retainer for securing a garment.

The method of purchase or cleaning may also include an additional step of folding the garment box containing the item of clothing into its final shape, thereby folding the clothing and box in unison or sequentially. Where garments are sealed in a waterproof bag in the garment box, the whale fin folding mechanism is employed to support the trapping of air in the bag, providing a cushion to further protect the garments.

Ideally the method further includes the steps of: placing the cleaned garment on a hanger; and securing a hook of the hanger to a fastener provided by the garment box. The fastener may be provided on an internal surface of the box. An integral hanger can also be incorporated, which may be perforated and can be torn out of the box to provide a hanger when items are sent with no (standard) hanger(s).

Optionally air and/or moisture may be extracted from the box once the garment is folded so as to further reduce volume and in order to ensure the garment remains dry and moisture free in transit.

According to another aspect of the invention there is provided a user selectable garment cleaning service, including the steps of: packing a garment to be cleaned in a garment box comprising: a plurality of side wall panels, a ceiling panel and a floor panel; and at least one retainer for securing a garment; specifying a delivery address; providing information sufficient to complete the cost of cleaning the garment; and delivering the garment box to a specified collection location.

In a yet further aspect of the invention can provide a drop and collect cleaning service comprising: placing at least one garment to be cleaned in a garment box according to any of the above described embodiments; dropping off the garment box at a drop off location; and collecting a cleaned garment in a garment box from a pre-arranged collection location.

Preferably the service further comprises tracking the garment through locations in stages of the cleaning service.

According to another aspect the invention can provide a drop and collect cleaning system comprising: placing at least one garment to be cleaned in a garment box according to any of the above described garment box embodiments; delivering the garment box at a drop off location; and delivering a cleaned garment in a garment box to a pre-arranged collection location.

Optionally the pre-arranged collection location may be a ‘click and collect’ network.

Preferably the system further comprises tracking the garment box from a first location to a second location. Barcodes, QR-codes or any other inventory tracking and stock control system may be used as part of this tracking system. Suitably, the drop off location is a parcel shop or intelligent parcel locker. In a preferred embodiment, the system comprises: a click and collect system which may provide a user with a suitable code via a mobile communication device. The code may be a number or an encrypted signal which can be replayed to a locker or at a collection location.

The system may incorporate a drop and collect dry cleaning system. The drop off location and the pre-arranged collection location may be the same location or may be different locations. The drop off location and pre-arranged collection locations may be for example, retail shops or intelligent lockers or a registered address.

The cleaned garment(s) are preferably returned to the pre-arranged collection location in a garment box or container, for example a bespoke cardboard garment box, which is designed to ensure that the garment(s) are not creased.

Preferably, the garment box is shaped and dimensioned to fit within a 500×300×300 mm dimension so as to allow goods to travel through national and international logistics networks. The garment box may be 500×300×300 mm or 500×300×200 mm and designed specifically to allow for the delivery of garments for the dry cleaning and/or laundry system to ensure cleaned garments (for example dry cleaned garments) can be placed and secured into the garment box or case and delivered without garments being creased to convenient collection points.

According to another aspect of the invention there is provided a method of delivering an article of clothing comprising the steps of: placing the article of clothing in a garment box or container; folding the garment box or container closed so that the container envelops the article of clothing; closing the garment box or container and placing indicia on the garment box or container suitable to indicate a destination address.

The garment box or container can be used with the fulfilment of clothing in any description including a dry cleaning and/or laundry system of an embodiment of the invention. Alternatively, the garment box may be used in any situation where it would be beneficial to package clothing without creasing, for example when posting new items of clothing to a customer, for example at a fulfilment station.

Embodiments of the invention solve the problem faced by online auction (e-auction) sites including the operators, sellers and buyers. Many used garments purchased from auction sites are likely to be cleaned as soon as they are received. This often adds costs and delays to the goods being available for use. Furthermore the posting and receiving of goods on e-auction sites remains a difficulty for many, and embodiments of the invention can facilitate an end-to-end fulfilment and cleaning process for such items, providing a reliable service for both the seller and buyer.

Optionally a seller can deliver garments for despatch where they are photographed and time and date stamped; cleaned and packaged in the garment box. This allows for delivery to a convenient collection point; the garments are ready to wear ‘out of the box’.

For example, embodiments of the invention may include steps such as the following:
A customer subscribes to a dry cleaning system.
A customer may wish to buy/sell something already held in the system.
A customer places the garment(s) they wish to sell or have already sold into either the garment box or directly into an intelligent locker.
A customer places an order online including a tracking number and a drop off location.
A customer places an order online including an intelligent locker location and identity.
A customer is assured that garments received at a cleaning/processing plant, if not already on record, are photographed, tagged and identified in the system.
A customer who wishes to sell an item that has not been catalogued or listed, has the option of obtaining an image and optionally uploaded with a description to a website.
A customer, the buyer or other third party is optionally provided with details of the goods (location and status) in real time throughout the process, once goods are listed.
A customer is offered the choice of having goods cleaned as well as offered with images of the goods prior to goods being packaged and despatched.
A customer is provided with updated and relevant tracking information.
A customer is offered an option of an update, such as a short message service (SMS) when goods are delivered with a system and order reference number.
A customer has the choice of payment of fees via a deposit account or via a settling service using a third party.

Embodiments of the invention, solving the problem faced by retailers of packaging and transporting goods are described below. Service operators provide a packaging solution to fulfil garments so that these arrive in a satisfactory condition, without defects or creases, therefore improving customer satisfaction and reducing customer returns.

Other embodiments of the invention allow retailers to reduce costs as the garment box can be assembled, ready for despatch, without the requirement for any additional materials for example tapes, adhesives or staples, therefore saving labour and time when packing and despatching goods.

Embodiments of the invention allow retailers to reduce packaging and delivery costs when despatching a number of items to a customer, as additional space may be utilised such as the void created once the garments have been secured into the box. Shipping costs will also be reduced as the overall dimensions ensure the volumetric size and weight is reduced, and this allows final mile delivery networks to be accessed, reducing failed deliveries and additional costs.

Embodiments of the invention allow for a cardboard version of the garment box to be re-used as opposed to single use boxes, as the invention is adapted to allow goods to be returned in the same box. For example if the contents are not required and need to be returned to the retailer.

Embodiments of the invention maximise the ability for retailers to utilise the growing number of logistics solutions for reverse logistics, simplifying the returns process and improving the customer experience. The dimensions of the garment box meet the required dimensions of logistics provider networks that include parcel drop off shops (convenience stores) and intelligent 24/7 lockers and removes the risk of items being refused at parcel drop off shops or not fitting intelligent lockers due to size of volumetric weight restrictions.

In addition or alternatively embodiments of the invention support retailers to reduce their carbon footprint and be more environmentally friendly. The garment box can be made from recycled cardboard and as it requires no additional materials it can be fully re-cycled and re-used where required.

Embodiments of the invention solve the problem faced by consumers using dry cleaning and laundry services as traditional laundrettes and dry cleaning outlets that do not offer ‘around-the-clock’ access and a choice of location to match customer's lifestyles.

Embodiments of this invention provide the equipment, technology and environment to provide a drop and collect dry cleaning and/or laundry system which allows registered customers to deposit and collect laundry and/or dry cleaning from a network of approved parcel or corner shops, and intelligent lockers or have it collected from or delivered to any postal address.

Customers are able to deposit garments at any approved parcel drop off location or locker box site and collect their laundry and/or dry cleaning from any approved collection location or locker box site.

Regular customers may also be provided with a bespoke designed garment box, such as for example a garment case. The bespoke box allows garments to be dropped off and returned in the same box which will have a unique identification associated to it allowing customers garments to be recognised as soon as they are accepted into the system,

Preferably, customers access the system through digital platforms of their choice. Embodiments of the invention may be based on a web based application (typically accessed via the internet, mobile website or applications on using a customer's laptop, Smartphone or tablet computers or smart television receivers.

Customers may need to be registered to use the service. To register an account the customer visits a website via a Smartphone, tablet or via the internet.

The system preferably provides real time updates to customers about the status of their dry cleaning or laundry order. Updates may be communicated to the customers depending on their preferred notification preferences, for example by text, email, social network alerts, or updates to account.

In preferred embodiments the system further comprises one or more of the following steps:
1. Completion of a registration or application form by the customer, for example by logging on or downloading an electronic version of the form;
2. Selection of the dry cleaning or laundry icon;
3. Selection of the type and number of garments to be cleaned;
4. Selection of the type and/or the speed of service required;
5. Use of any promotional offers;
6. Selection as to whether a customer wants the garment(s) to be returned to the same location as they are dropped off for cleaning;
7. Selection of location of the chosen location via a mapping search facility; and
8. Confirmation of order, submission of the order and commitment to payment.

The customer is then ready to drop garment(s) off in the garment box, or case to one of the approved locations (e.g. parcel shop network or intelligent 24/7 locker compartment. Customers can also have orders collect and delivered back to any registered address.

Upon registering the customer sets up a username and password, and provides the necessary account details around customer name, address, mobile telephone number or users may make use of social media platforms. This allows the proprietor to recognise a mobile telephone number and send relevant information to them such as reminders, allow users to search for their nearest location, send users tracking information about their orders, as well as of course supplying special offers in the form of vouchers or tokens.

Customers can also set favourites such as their location, favourite services, special instructions such as type of detergent to use, washing conditions and location of stains and type and nature of stains. The location of stains is able to be completed using a manual slip of paper or a digital photograph which can be included in an e-version of an order.

Customers may be requested to register payment details (including credit, debit, PayPal (Trademark) accounts, Google (Trademark) wallet, and Amazon (Trademark) wallet) for which the services fees will be deducted.

Customers may be required to agree to the service terms and conditions to complete registration. Customers may be sent any relevant service information and garment bags or the garment box or garment case.

Once the customer has registered, logged in and wishes to place an order they will simply follow the web/mobile and tablet application screen flows.

First time customers may be sent a welcome pack which will contain an individual laundry/dry cleaning bag or mailing bag (which will have a unique identification associated to it). Customers also receive garment box, such as for example a branded garment box or case and any relevant information.

The garment box may further include tracking (RFID)/barcode labels. Customers place garments into the garment box, for example a garment box or case with completed documentation and either attached a pre-printed bar-coded mailing label or print one online. This label is attached to the garment box.

There is an option allowing customers registering for the first time who require laundry/dry cleaning immediately to place ordered immediately. They are provided instant access to log into the system and then follow the steps to print a bar-coded mailing label from the online system. Customers are then able to arrange a collection whereby the garment carrier is presented to them at the time of collection from the specified address.

Customers complete the relevant steps and drop their garment box (for example a box or case) containing their garment(s) to any location, or arrange for a collection from any address. This may include:

Selecting to drop their order into a locker, for which they will be provided a Personal Identification Number (PIN) allowing them to gain access to a secure locker; they would receive confirmation of dropping off by SMS or email and a tracking number to track their order.

Selecting to drop their order into one of the agreed retail partner's locations (typically local shops and convenience stores). Upon handing their box or case to a member of staff their order will be scanned into an ePOS system and they receive confirmation of handover and a tracking number to track their order.

Selecting to request a collection from an approved logistics partner. Upon handing their box or case to a member of staff their order will be scanned into an ePOS system and they will receive confirmation of handover and a tracking number to track their order.

The garments are thus fully ‘trackable’ by the customer and will be returned to the dry cleaning/laundry factory whereby the garment box or case with its unique identification will be scanned into the system. The system then updates the status of the order as received.

The processing factory optionally obtains a digital image of each garment and places a unique reference to each customers garment to provide a relationship with the garment and the customer. This is ideally done by using a Radio Frequency Identification (RFID) tagging or NFC tagging, typically by attaching the unique identification token to the clothing tag. This allows the customer's account to be updated and individual garments stored in favourites allowing for customer preferences to be updated in the future, for example to take extra care, or extra softener needed.

Each garment is then tracked automatically through the process of the dry cleaning/laundry cycle, and it allows for individual garments to be located in the process at any time.

The processing factory may have a number of workstations within the factory operation, and automation allows the individual garments to be scanned through the process until the garments are packed and ready for delivery for customer collection (at this point the customer will get notification via email or SMS with the relevant collection reference numbers or PIN codes)

At the end of the process the garments will be placed into the garment box or case which means that they can remain hung and be returned without any creases but fit into a box or case less than 500 mm×300 mm×300 mm in dimension.

Customers may be notified throughout the delivery of their orders, and when their orders are ready to be collected from one of approved retail partners' locations, or one of the intelligent locker partner sites.

Embodiments of the invention allow customers to pick and choose the drop off and collection point of their dry cleaning/laundry using the application and mapping software, and allows the clothes and any additional items (such as shoes) to be delivered to any location including ‘click and collect’ networks in the same box without getting creased.

In embodiments of the invention, internal surfaces of the box can be used to provide additional features, such as an integral polished surface for used as a mirror, or space for marketing material, messages, logos and the like.

In other embodiments of the invention, the box, method and system described above can be used to: support e-auction sites allowing goods to be sent, image(s) taken, and the goods to be cleaned and delivered to the recipient (buyer) on behalf of the seller; support recycling of garments e-auction sites; and to allow the fulfilment of new, used or cleaned garments with or without a hanger.

Preferred embodiments of the invention will now be made, by way of example only, and with reference to the drawings, in which:

### BRIEF DESCRIPTION OF THE DRAWINGS

FIG. 1A is a schematic view of the outside of an example of an unfolded garment box, according to an embodiment of the invention;

FIG. 1B is a schematic view of the inside of an unfolded garment box containing a suit, according to an embodiment of the invention;

FIGS. 2A-2C are schematic views of the garment box containing a suit being folded so as to prevent creasing of the suit, according to embodiments of the invention;

FIG. 3 is a diagram illustrating, in the form of an unfolded blank, an alternative embodiment for the box;

FIG. 4 is a diagram illustrating a fitting mechanism for a hanger to the garment box, according to an embodiment of the invention;

FIG. 5 is a diagram illustrating the outside of another alternative box according to an embodiment of the invention;

FIG. 6 is a diagram illustrating the inside of the box of FIG. 5, according to an embodiment of the invention;

FIGS. 7 to 15 are diagrams illustrating various states of folding of the box of FIG. 5, and various garment retaining uses therefor, according to embodiments of the invention;

FIG. 16 is a diagram illustrating locking tabs according to an embodiment of the invention;

FIG. 17 is a diagram illustrating a further alternative box according to another embodiment of the invention;

FIG. 18 is a diagram illustrating a partially folded view of the box of FIG. 17, according to an embodiment of the invention;

FIG. 19A to 19C and 20 illustrate various configurations for the box of FIG. 17, according to embodiments of the invention;

FIG. 21 illustrates a box according to an embodiment of the invention in use, opened and suspended from a door;

FIGS. 22 to 24 illustrate assembly of a box according to an embodiment of the invention;

FIGS. 25 to 27 illustrate a sealing arrangement, for sealing the box according to an embodiment of the invention;

FIG. 28 illustrates a so-called ‘whale fin’ attachment in a box according to an embodiment of the invention;

FIGS. 29a to 29c illustrate a base portion of a box according to an embodiment of the invention; and

FIG. 30 illustrates a racking formation according to an embodiment of the invention.

### DETAILED DESCRIPTION OF PREFERRED EMBODIMENTS OF THE INVENTION

As noted above, embodiments of the invention provide a garment box, a method of inserting a garment into such a box, and a drop/collect system as outlined in more detail above.

The garment box can take a variety of different forms, as referred to in the below sections and accompanying drawings, along with other alternatives suggested. Generally, the box has a plurality of side walls, a ceiling and a floor, and has at least one garment retainer, which may be configured to retain a garment between the retainer and a respective panel of the box. These and other features described below allow more effective prevention of crumpling and creasing of the garment, by more effective spreading of the load around the panels of the box, and around or along the retainer(s).

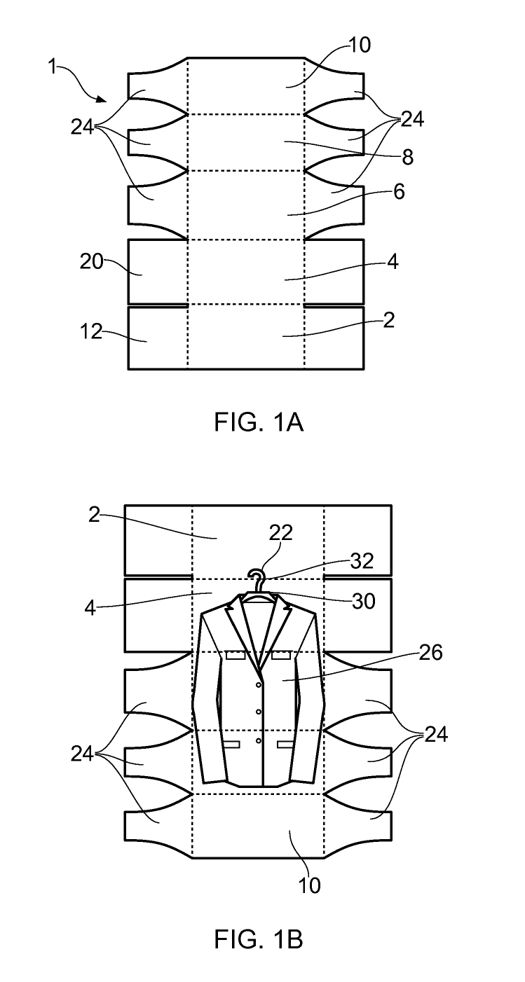

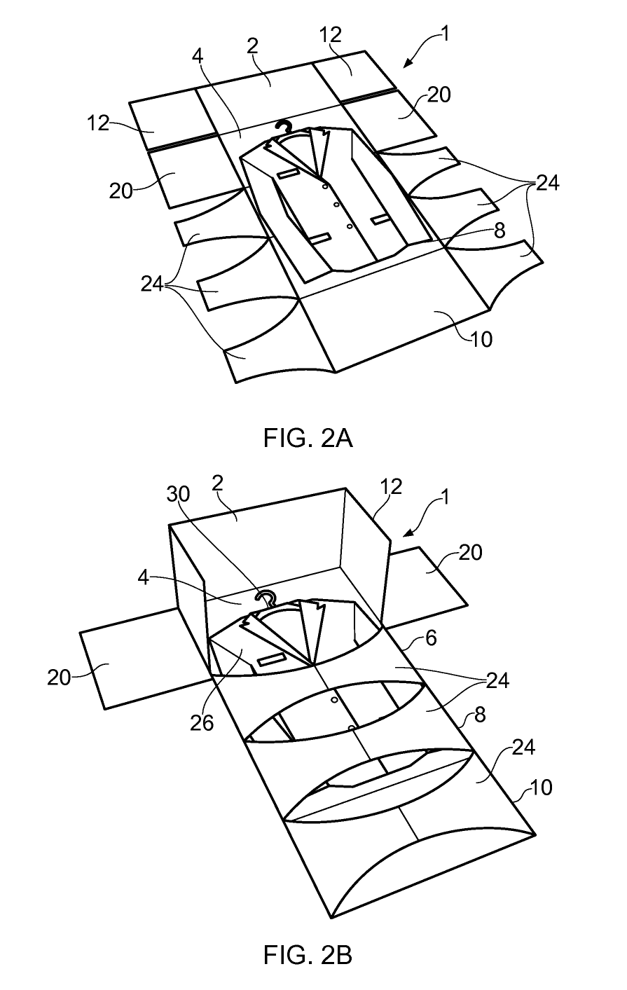

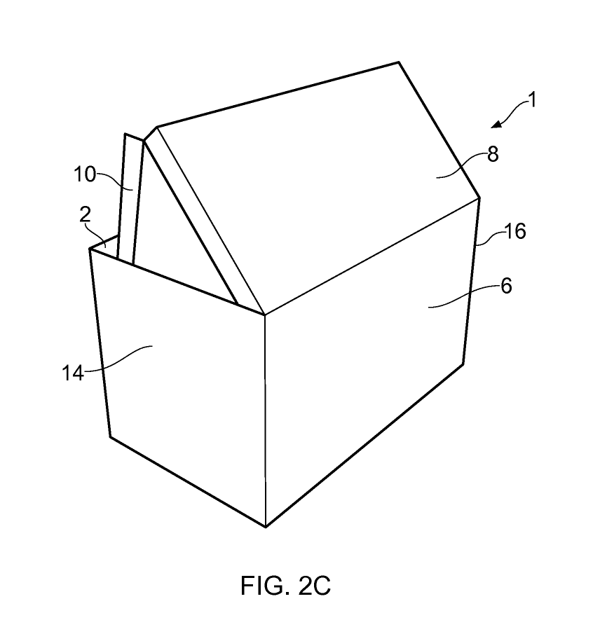

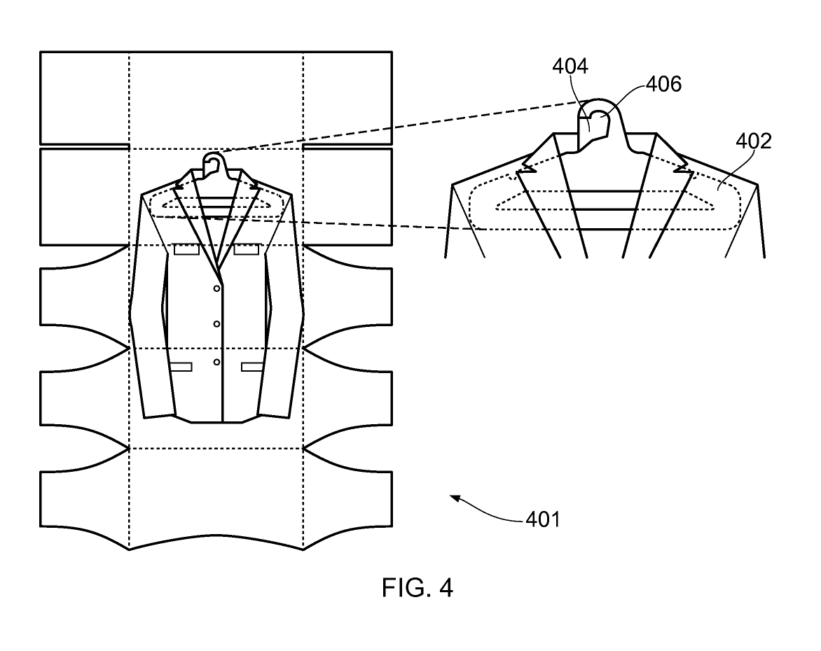

FIGS. 1 and 2 illustrate a first embodiment of a garment box according to an embodiment of the invention. Referring to FIGS. 1 and 2, the garment box 1 comprises five panels: a first side section 2, a bottom section 4, a second side section 6, a top section 8, and an internal flap 10 which is preferably curved, so that when it is deployed flap 10 does not crease the top of the suit around the region where the hanger 30 is connected (see FIG. 4).

The first side section 2 comprises two end flaps 12 for forming the end faces 14 and 16 of the box 1. The internal surface of the first side section 2 provides a fastening 22 for receiving and engaging a hook from a hanger. The bottom section 4 comprises two end flaps 20 for forming the end faces 14 and 16 of the box. The second side section 6, the top section 8 and the internal flap 10 each provide two retaining flaps 24 for securing a garment in position. The flaps are formed as extensions of the respective sections on the blank, and separated from the main panel by a fold. In use therefore, the flaps are hinged on the main panel 6, 8 or 10, and are foldable into a deployed retaining position.

The garment box is dimensioned to be approximately 500 m×300 mm×300 mm or 500 mm×300 mm×200 mm (for example, an alternative may be 520 mm×300 mm×140 mm) so as to allow goods to travel through national and international logistics networks.

In use, the customer places the suit jacket 26 on a hanger 30. The hook 32 from the hanger 30 receives and engages the fastening 22 provided by the internal surface of the first side section. The customer lays the suit jacket 26 along the internal surface of the box 1.

The suit jacket 26 lies along each of the internal surfaces of the bottom section 4, the second side section 6 and the top section 8. Each of the retaining flaps 24 provided by the second side section 6, top section 8 and the internal flap 10 are folded into contact with the suit jacket 26 to retain/secure the jacket 26 in place.

The customer then folds the five panels of the box 1 into position to provide the garment box 1 and the jacket 26 is held securely in place without creasing.

In this embodiment, the garment (here a suit) is arranged so that a top part is laid across what in the assembled box is the bottom or floor panel, a middle section is retained across a side panel, and a bottom section is retained along a ceiling panel. This spreading of the load across several of the panels of the box, rather than merely one or two as in prior containers, provides greater protection against creasing and crumpling of the garment. This is in part because the portions are retained at different orientations (horizontal and vertical), thus alternating the load type on the garment.

The advantage is the greater for the retention being on adjacent or consecutive panels, rather than there simply being a retaining feature on either side of a box. The advantage is also preserved over folder-type prior containers, which assumed side-walls of the folder (some without retaining features) would protect the garment, as in embodiments of the invention the retaining is a positive engagement of the garment, against the associated panel, rather than merely an assumption that the folded nature of parts of a folder passively provides sufficient retention.

The retention along several panels of the box also allows the box to be more cuboid in shape than previous containers, and is therefore more susceptible to be dimensioned appropriately for standard national and international freight.

The retention of the garment around the edges of the box, rather than in some way through the centre of the box or as a concertina in part of/throughout the box, also provides the advantage of removing clutter from the box, and prevents parts of the retaining flaps and mechanisms from interfering with each other. In addition, this arrangement may provide a void or space in the centre of the box in which additional items can be placed for transit.

The retaining flaps are part of the sheet blank and are therefore generally planar. This provides a better spread of load and coverage of support than a point or linear retention. Particular advantage is obtained for portions of the garment retained on the top/ceiling or bottom/floor panels of the box; here the load on the garment is in a vertical direction. As the planar retaining flap for this portion (and the panel on which it retains the garment) is (are) perpendicular to this vertical direction, the load will be spread along the retaining flap surface, avoiding creasing of the garment which would arise with a point or linear, or even a narrow oblong, retaining means.

The retainers 24 are advantageously shaped to protect retained garments. As shown in FIGS. 1, 2 and 3, the edges of the retaining flaps in this embodiment (and in others, and applicable to other embodiments as an alternative) are curved, between the outer tips and the panel on which the flap is mounted. The curve is in this embodiment a cut away, so that the edge is concave relative to what would have been a straight line between tip and panel. This curve means that when the retainers are deployed, the edges encountering the garments are curved rather than straight (so that the voids between retainers resemble a pair of crescent or moon-shapes, as can be seen in FIG. 2B), which prevents the edges from cutting into the retained garments excessively, thereby producing less creasing and crumpling.

In this embodiment and in some others described, the garment is arranged so that a top portion of the garment lies in the assembled form on the floor of the box. In other embodiments, it may be that the top portion of the garment is retained on a side section, or on a ceiling section. For certain longer garments, each inner side of the box may be used for retention.

However, the arrangement of the top portion to lie on the floor of the box may provide an advantage where the top portion is the heaviest part of the garment, for example in a suit. This is because the likelihood of movement, and therefore of creasing/crumpling may be lowest for the portion retained on the floor of the box, and therefore the portion most likely to move in transit (the heaviest) is advantageously laid on the floor.

In this embodiment there are effectively two panels on one side of the box, as the most distal panel 10 is folded on assembly to slot into the box and abut the first panel 2, as shown in FIG. 2C. In other embodiments as will be seen below, further panels are added to the unfolded blank, so that more sides (or the ceiling or floor) of the box effectively have an additional panel. In this embodiment, the fit of the section 10 into the assembled box and next to the first section 2 is sufficiently snug to maintain the additional panel in place. In other embodiments, an additional fixture or tab may be used if further means is necessary to maintain the additional (inner) panel abutting against the original (outer) panel.

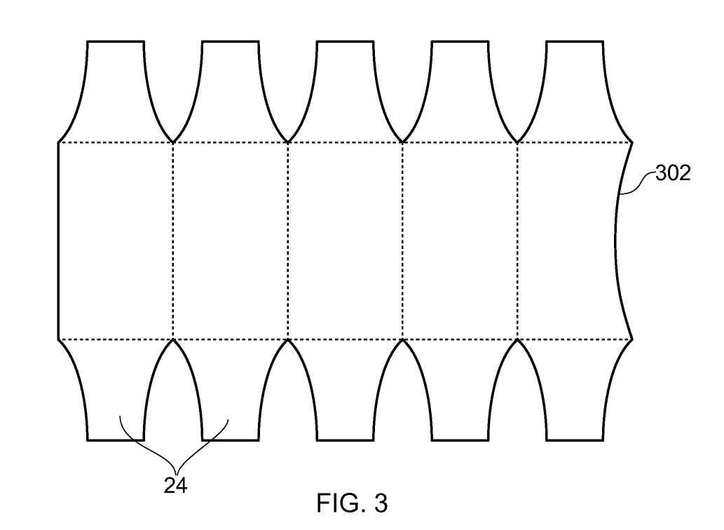

FIG. 3 illustrates an alternative embodiment, showing a curved outer edge (302) of the distal panel, which as noted above prevents contact of that panel with the enclosed garment when the box is assembled. The curve straddles the garment, the end sections of the curved edge contacting the outer portions of the opposite panel to which the garment does not extend.

Referring briefly to FIG. 4 there is shown an overall view of a cardboard hanger 402. In this embodiment, the cardboard hanger replaces a normal hanger to be hooked to a fixture as in FIG. 1. In this embodiment, the hanger is formed separately from the box blank (although this could be formed from the same cardboard sheet) and is therefore initially separate, but is then attached to the box. However, the hanger is then detachable from the box as described below.

The fact that a cardboard hanger 402 is used means that embodiments of the invention include a biodegradable/recyclable material and so provide an environmentally friendly product.

FIG. 4 shows the means of incorporating the hanger 402 with the box 401 by a staple (406). Perforations along a border between the hook of the hanger and a retainable section 404 allow the hanger to be removed by tearing along the perforations, leaving the stapled retainable portion 404 attached to the box 401.

In an alternative embodiment a push-out handle (not depicted) has finger holes to assist gripping and carrying. In another alternative, the hanger may be formed as an integral hanger, as part of the same blank as the box. For example, this could be done by cutting a final panel to the hanger shape, and folding the hanger over. Again, perforations could be used to allow the hanger to be removable.

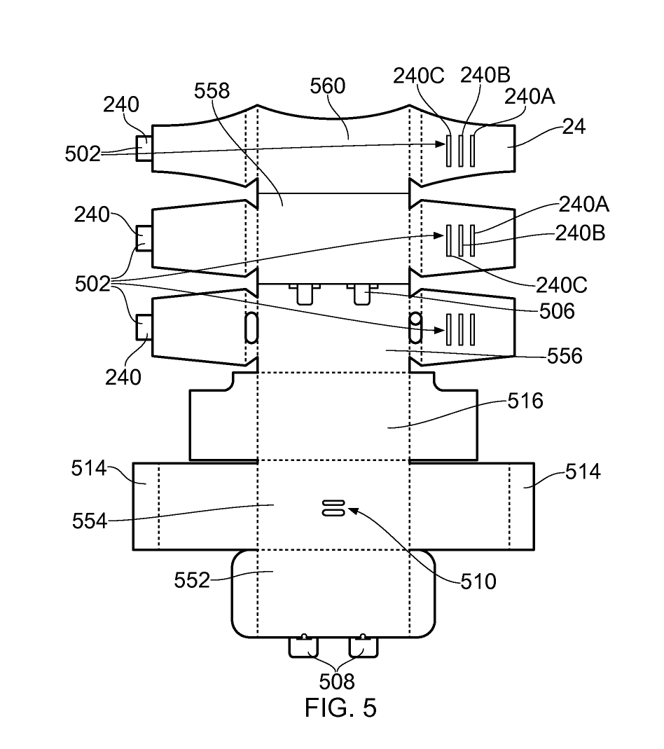

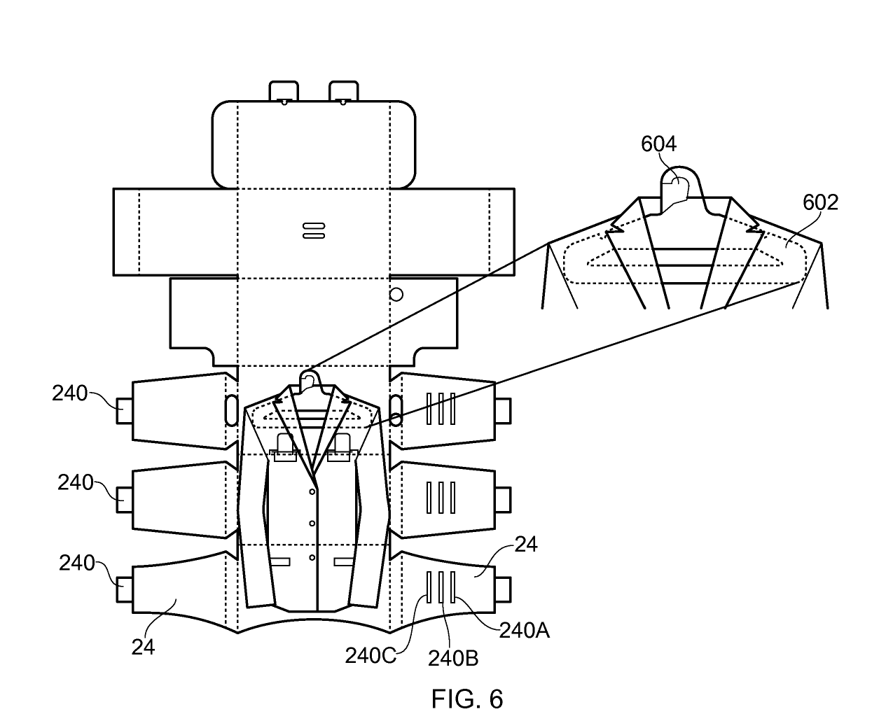

FIGS. 5-15 show alternative embodiments. In particular FIGS. 5 and 6 illustrate the outside and inside of an alternative embodiment of the box respectively, indicating generally at 502 a retainer adjuster, which can be adjusted on the number and thickness of garments in the box. This provides the ability to apply enough pressure to hold the garment(s) in place, but not to crease the garment(s).

The main sections or panels in this embodiment are similar to those in FIG. 1, here providing a lid/ceiling and/or side panel 552, and further side/floor panels 554, 516, 556, 558 and 560 in the same consecutive pattern (as shown in FIG. 5).

Retaining flaps 24 are coupled to the sections 556, 558 and 560, here formed as part of the same blank and separated from the main panel by a fold. The flaps 24 are provided with a means of adjustment 240, 240A, 240B, 240C that serves to adjust the position of the retaining flap without causing creasing. The means of adjustment is formed of mating parts, the insert 240 and the three slots 240A, 240B, 240C.

FIG. 5 and FIGS. 6 to 15 show three slots 240A, 240B, 240C on each flap 24 wherein the insert 240 may be placed in any one of the three slots 240A, 240B or 240C depending upon the contents' shape and size. The choice of slot effectively lengthens and shortens the retaining length of the retainer pair formed from each set of two cooperating flaps 24. The volume (partially) enclosed by the retainer is therefore increased and decreased.

The insert or node 240 placed in slot or notch 240C being the tightest arrangement, thereby securing the garment closest to the box wall. The insert 240 slotted into 240A for the loosest arrangement, for example when the garment 25 may be a large jacket or there may be more than one item may be in the box.

The slots 240 A-C are incrementally positioned so as to allow the retainers of the box to be sized dependant on the number or size of garments.

Here a simple insert/slot system is used, however other types of connection for the pairs of retainer flaps may be used. For example, an insert or node having a lozenge profile could be used, the outer lobes of which may be temporarily partially folded during insertion into the slot, and allowed to revert after passing through, so that the lobes contact the reverse side of the slot edges, preventing removal of the insert from the slot. Other known more permanent fixtures could be used to lock the flaps together.

FIG. 5 also illustrates the cooperating sets of locking tabs 506 and 508, on the box which ensure that when folded the box is securely closed in place, but can easily be opened without damaging the box or its contents.

In addition FIG. 5 illustrates the option of a perforated handle 510, to allow for easy transportation. The handle perforations can be formed in the cardboard blank, and punched through when needed to form the handle. Here the handle is shown formed in panel 510, however if panel 552 is made as the lid/ceiling of the box, then the handle could be formed in this panel (or any other panel as needed).

The panel having the handle can be reinforced with strengthening tape, so that the hole punched to form the handle is reinforced by the tape. The tape can have a rebound effect, so that once the user lets go of the handle portions, the tape tension restores the handle perforated portions to the plane of the panel. The tape can also provide a further sealing effect against ingress of water through the perforations.

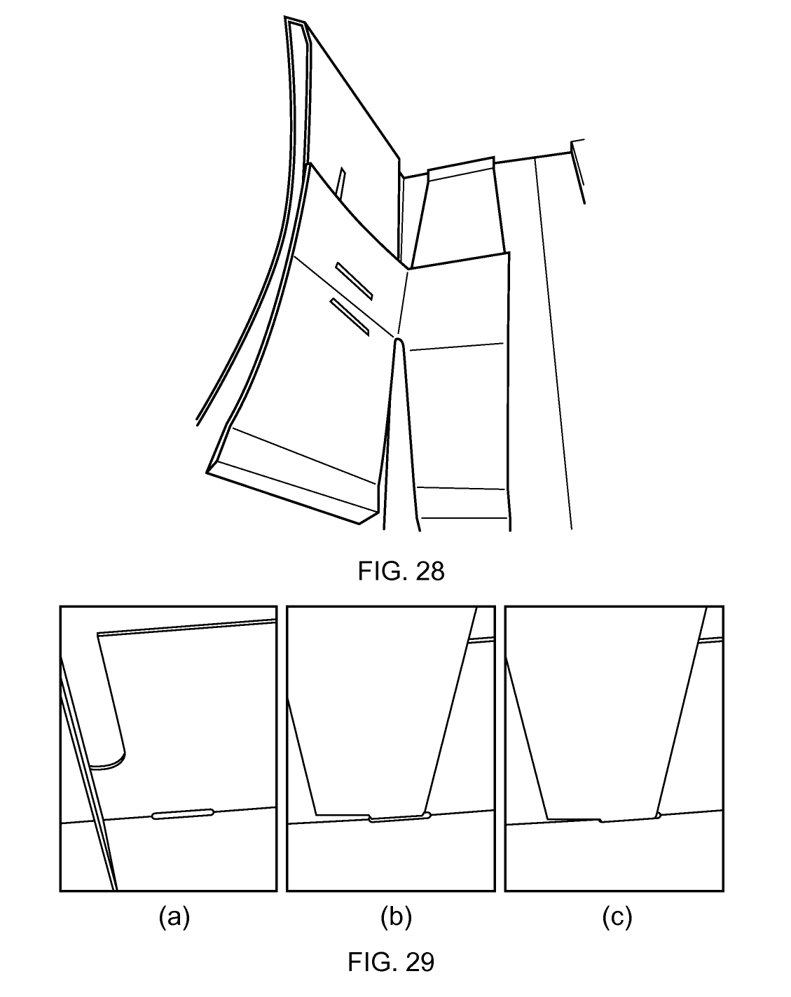

In one embodiment, a handle can take the form shown in FIG. 28. The perforations are formed either side of a central handle portion which can be grasped by the user. Both features can be reinforced internally by tape, but in addition the central handle portion can be backed by a composite (for example nylon) strap mounted on the inside of the box, to spread the load on the handle along a line along the top panel of the box.

This reinforcement of the handle is also advantageous in certain embodiments described below, in which the box or portions of it can be hung. Where the handle is reinforced, the weight of the box and garment can be borne by the handle in a hanging arrangement.

FIG. 5 further indicates additional side panels 514, which can be folded to reinforce the shape of the box. On folding the panels of the blank and the retainers to form the box, the additional side panels 514 contact the inner surface of the adjacent panel 516, providing additional stiffness laterally. This and other such features such as the locking tabs 506/508, ensure that the garment box can be assembled, ready for dispatch, without the requirement for any additional materials, such as tapes, adhesives, or staples.

FIG. 6 illustrates many of the same features as in FIG. 5. In addition, a similar feature to that of FIG. 4 is shown, namely the perforated tearaway section 604 of the hanger 602 which can be stapled to the box.

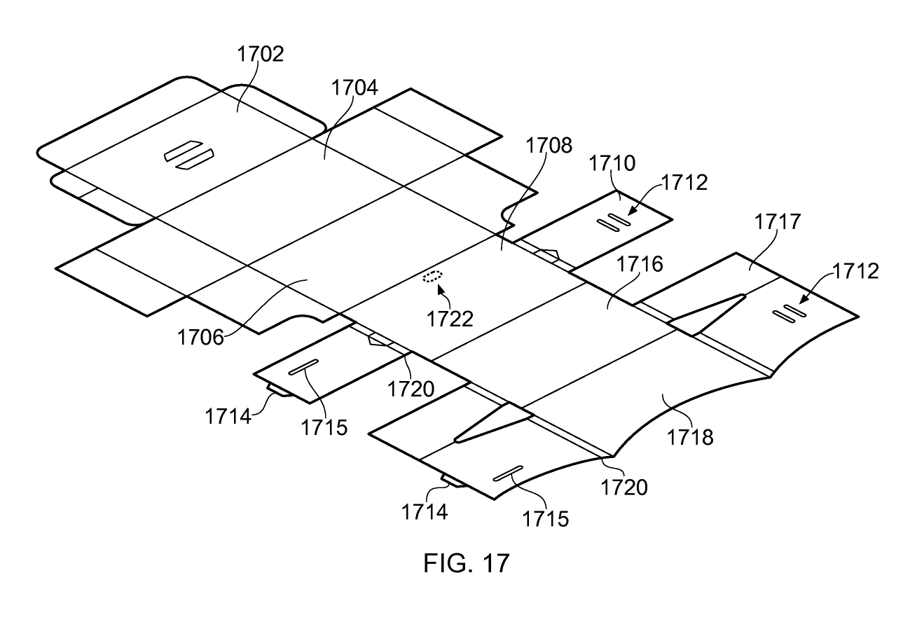

In an alternative embodiment, the box can be used without any hanger. As the retaining features described above and below secure the garment so effectively, and distribute the weight of the garment evenly around the box, in certain cases there may be no need for a hanger. The garment can simply be placed on the box (or tri-fold section as set out in relation to FIGS. 17 to 20 below), folded if necessary, or simply arranged for example in the typical manner of laying out a suit jacket (as in FIG. 6 for example, but without the hanger) and the retainers deployed. The box or tri-fold section can then be assembled, retaining the garment without need for the hanger.

In one embodiment, a method comprises arranging a jacket face down on the panels, so that the lapels contact the panel(s). The box or tri-fold can then be assembled, folding the retainers, and the jacket will then be retained and suspended so that in a typical embodiment when the box is upright, the jacket will be facing lapels-up inside the box. This can prevent creasing to the shoulders of a jacket and arms, as many such jackets naturally fall in this way.

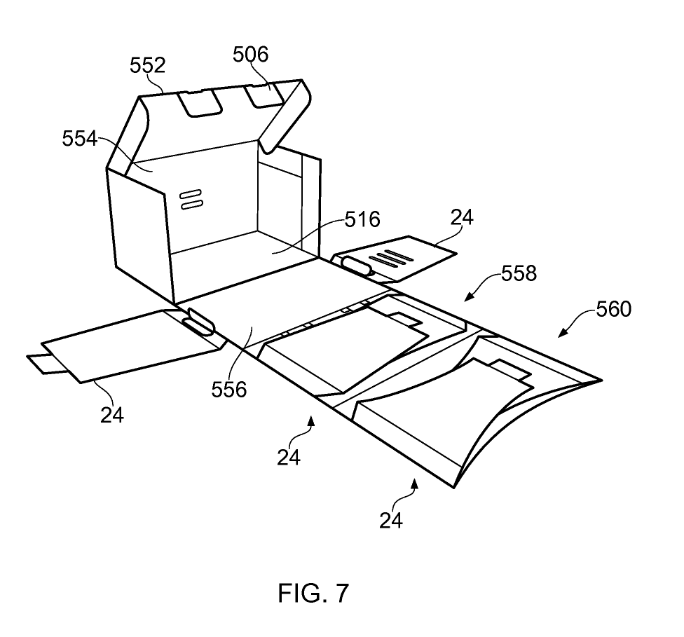

FIGS. 7 to 15 illustrate folding variations and alternative uses of the embodiment above noted with reference to FIGS. 5 and 6. FIG. 7 shows the same box, having panels 516, 552, 554, 556, 558 and 560, and the retaining flaps 24, in a partially folded state, with three of the panels 552, 554 and 516 formed into the partial cuboid into which the other three panels will be folded, one (556) forming the final side of the box, and the other two internal panels to be arranged parallel with the existing sides. The cooperating tabs 506 and 508 are then mated to secure the box. In FIG. 7, one set of retaining flaps is shown in the open state, the other two in the deployed state.

FIG. 8 shows the same arrangement, now with all retaining flaps deployed. In this case, the adjuster has been set (802) at the shortest/tightest setting, either for transporting without a garment or for retaining a slim garment, as little space is left between the flap and the panel under it.

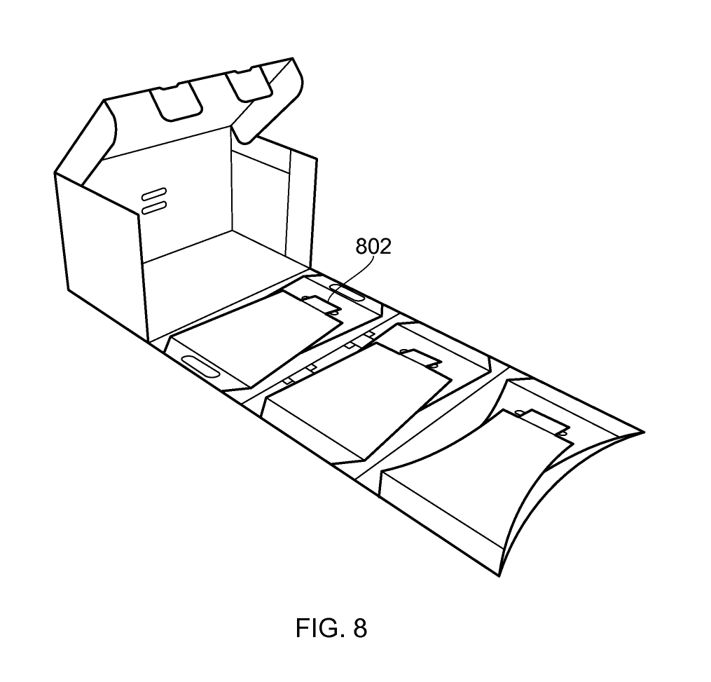

FIG. 9 shows an embodiment with the same box in which the inner space (902) provided by retaining the garment around the edges of the box, is utilised for additional items, here a further box 906 containing a pair of shoes 904.

FIG. 10 shows the same box, again with retaining flaps on the tightest arrangement, as they are retaining a light garment such as a dress (1002). The dress also extends along four panels of the box, so that the top section is laid out on the panel without a retaining flap. Here, the hanger (detachable or normal type) is affixed to the box as shown above or hooked to a fixture, to secure the top section.

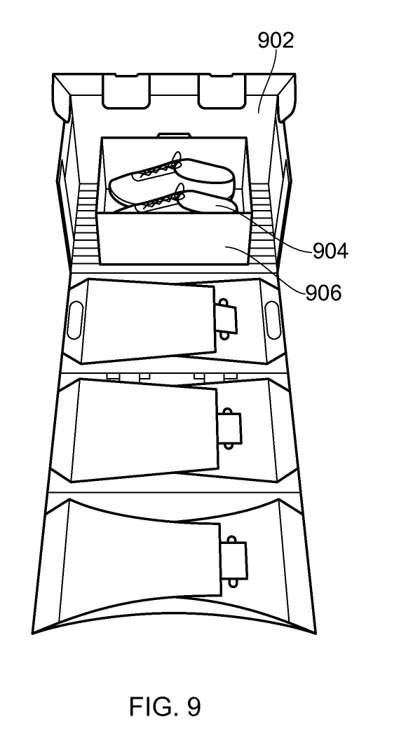

FIG. 11 again shows the box, this time in an embodiment in which the loosest arrangement (1104) of the adjustment means is being used, as the box is being used to contain several garments (1102). As can be seen here, in the loosest arrangement, folds (1108) in the retaining flaps are actuated, to accommodate the additional garment size and shape, and allow for extension (1106) of the retaining flap pair.

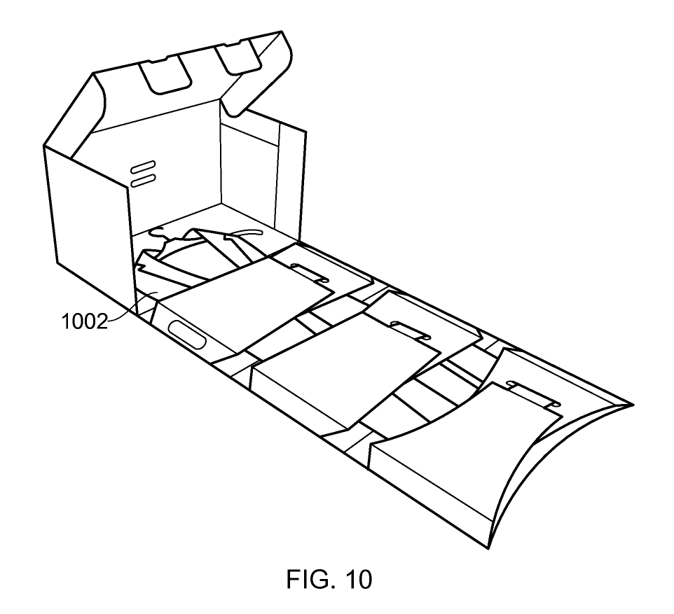

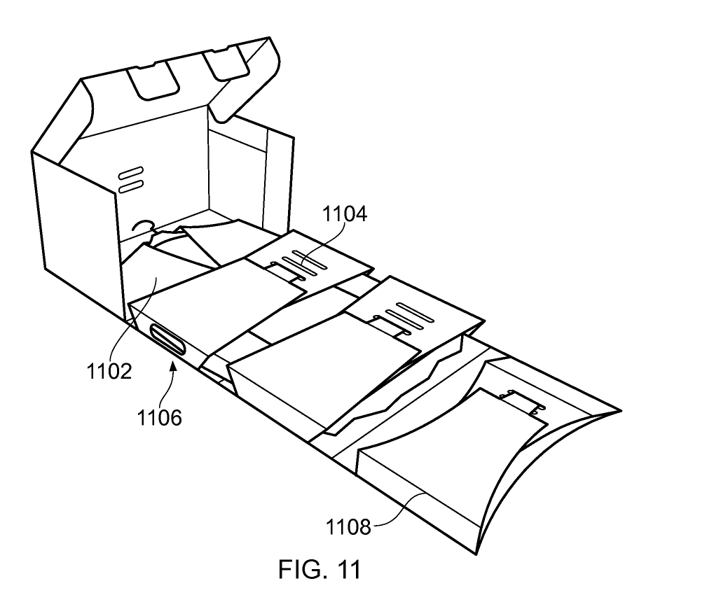

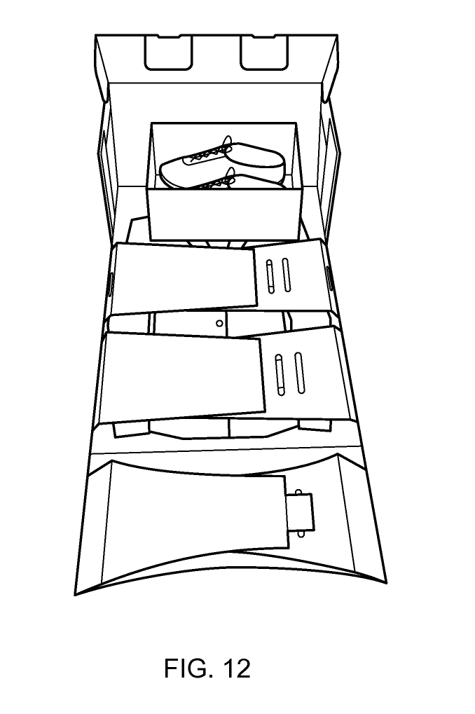

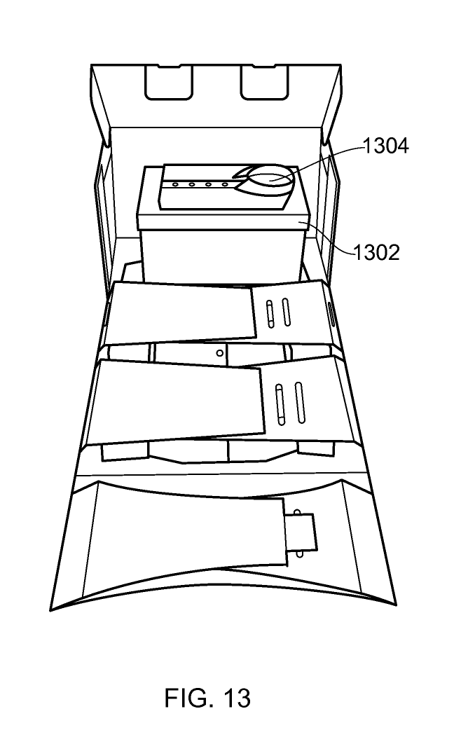

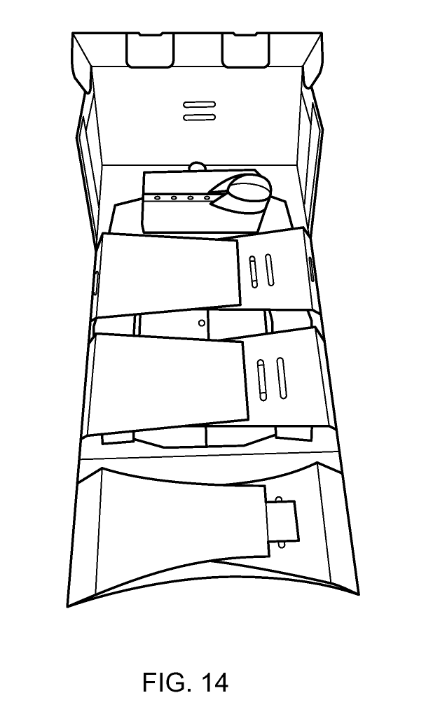

FIG. 12 shows an arrangement of the box having a garment as well as an additional item, again a shoebox. FIG. 13 shows an arrangement in which the additional item is a box 1302 with a further additional folded shirt 1304 placed on top. FIG. 14 shows an arrangement with only an additional shirt. The additional items inserted may abut the inner surfaces of the box, such as the inner surfaces of the retaining flaps, in order to protect the garment retained around the sides. In an alternative, the additional items may be affixed to fixtures included within the box, the fixtures for example attached to the inner surfaces of the retaining flaps.

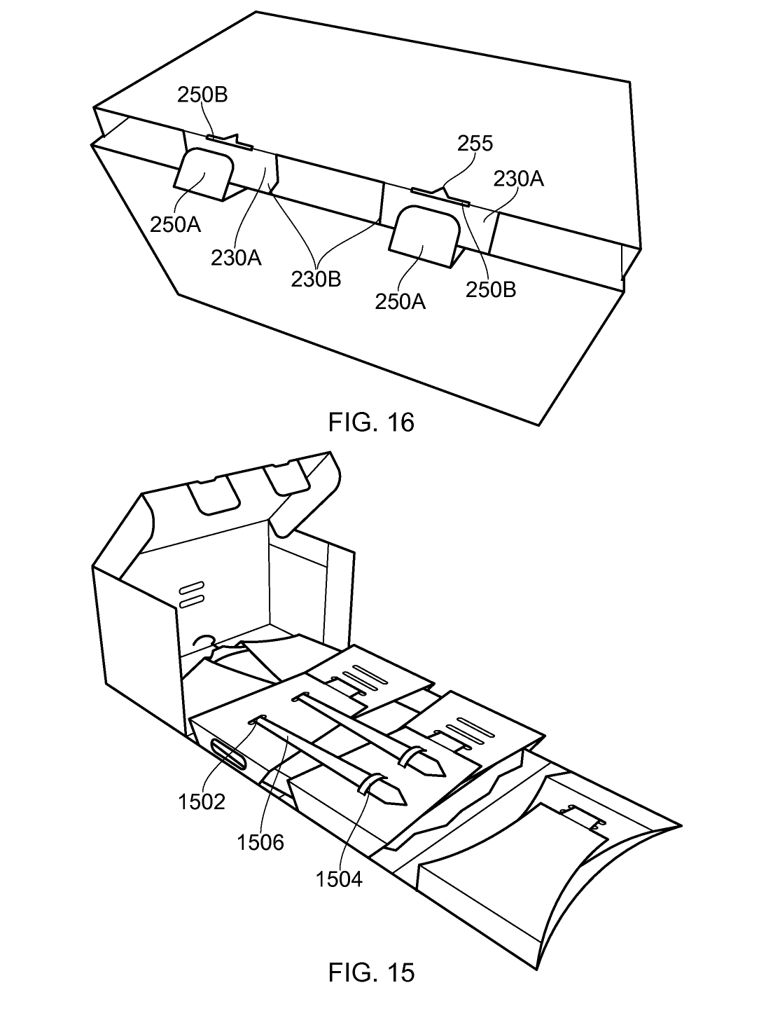

FIG. 15 illustrates an embodiment similar to the same box, in which slots 1502 and loops 1504 are provided on the inner surfaces of the retaining flaps in order to accommodate and retain further smaller items, such as ties 1506.

FIG. 16 shows in detail the cooperating tabs illustrated in FIGS. 5 and 6. The lockable tabs 230 include a first tab 230A and second tab 230B so as to secure the box for transportation wherein the first tab 230A is inserted into a first aperture 250A and the second tab 230B is inserted to a second tab 250B. The second aperture 250B includes a triangular cut out 255 so as to provide a figure hold for the user to unsecure the second tab 250B so that the box may be opened.

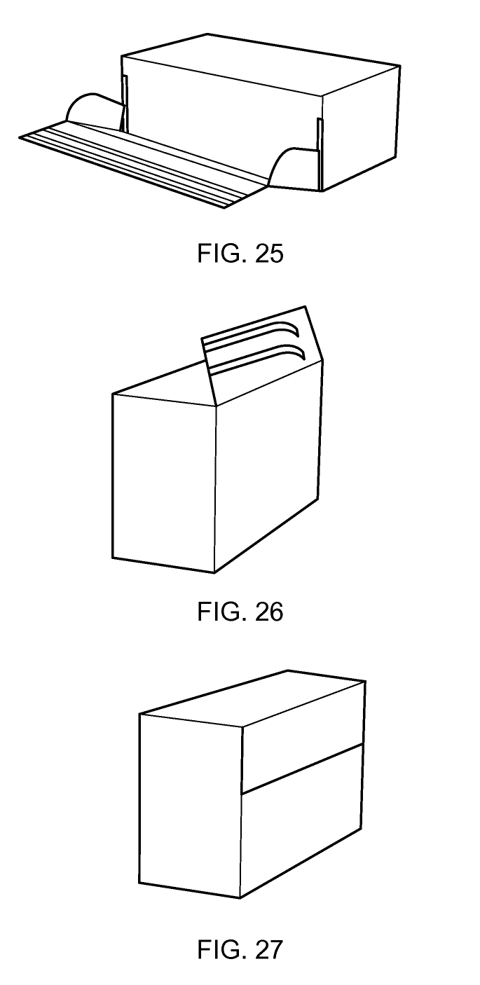

The box can also be provided with different closing/locking and sealing features, such as those illustrated in FIGS. 25, 26 and 27. A double sided tape re-sealable sticker, or set of stickers or other temporary fasteners, such as Velcro can be used as sealing or closing means. The customer can tear open the sticker or fastener, but also easily re-seal. This speeds up the pick and pack process, and allows for multiple uses of the box. The sticker or fastener can be provided on any closing or sealing part of the box, for example on the lockable tabs (230, 250).

In the example shown in FIGS. 25 to 27, a closing lip attached to the top section (1702) of the box is provided with a set of a minimum of two peel and stick strips.

The box can be assembled as shown in FIG. 25, then the strips removed (FIG. 26), and then the closing lip with exposed strips brought down into contact with a side panel of the box, for example the panel 1706 of FIG. 17. This reliably seals the box, but allows easy opening and later re-sealing, particularly useful for customs officials, airport security and e-auction customers. Such strips could be provided on other panels of the box, for greater security.

FIGS. 17 to 20 illustrate another alternative embodiment for the box, similar to that shown in FIGS. 5 and 6. Consecutive panels 1702 (the top or ceiling panel), 1704, 1706, 1708, 1716 and 1718 are formed as a continuous blank defined by folds, with other further continuous sections included and defined by folds as described below.

To provide greater security and so that the box holds its shape, the flaps on side of the panel 1704 can be provided with an additional tab on the underside of the flap, and the junction or crease between the panel 1706 and the attached flap can be provided with a slot. On folding the panels 1704 and 1706 to form the right-angle of the assembled box, the tab can be inserted into the slot, to provide greater rigidity.

Two different types of retaining flap 1710 and 1717 are provided, attached to adjacent panels 1708 and 1716/1718 of the box. Adjustment of the retaining flaps is provided by slots 1712 and nodes 1714, and accommodation of the increased size of the retainer by the folds 1720. Slots 1715 are provided for securing smaller items such as ties. Perforations 1722 are provided for a hanging arrangement described below.

The retaining flap 1717 forms the whale-fin feature of this embodiment of the box. Instead of being mounted on one panel, the retainer is arranged to cooperate with two adjacent panels of the box. The retainer arms are each divided into two sub arms in the region of the hinges, a first sub-arm being hinged to the edge of a first adjacent panel (1716), and a second sub-arm being hinged to the edge of a second adjacent panel (1718). This forms an indent between the two hinged portions, on each side of the retainer, as can be seen in the deployed/folded view in FIG. 18.

As the retainer is hinged on both panels, and the panels 1716 and 1718 are foldable, the retainer is also foldable along a line in the region of the fold between these two panels, so that the panels and retainer can be folded up into the assembled box.

This whale-fin arrangement means that this embodiment only requires two closing mechanisms, rather than three (as shown in FIG. 7) whilst still providing the retention necessary, and in some cases providing better retention, for example through greater surface area of the whale-fin section. This is allowed by the whale-fin section being foldable in two directions—firstly the retainers folding inward for deployment, and secondly the deployed retaining whale-fin section folding up as the panels are rolled up into the assembled box.

If the packed garment is packed with a liner, such as a polythene sheath, the retainers of all embodiments of the invention can act to trap air in the sheath/liner, providing a cushion. This is especially true of the whale-fin design shown in FIG. 17—the large surface area of the whale-fin section on the two panels 1716 and 1718 acts to spread the trapped air cushion evenly over the retained garment, thereby providing a protective layer of air cushioning over as much of the garment as possible. This air trapping feature can also help to seal the garments against moisture ingress.

The whale fin also provides extra protection for the goods, as other accessories placed in the void will not come into contact with the garment(s).

These lower panels, with retaining flaps 1710 and in particular 1717, form a tri-fold section of the box. It is in part this tri-fold arrangement (with the whale-fin lower portion) which allows the lower portion (which may be detachable, see below) to be folded and/or rolled up into either of the sizes of box, 500 mm×300 mm×300 mm or 500 mm×300 mm×200 mm as noted above.

The lower panels have three panels or sections 1708, 1716 and 1718, and two folds on the main section between these panels, making the tri-fold. Optionally branding and/or instructions can be placed or printed on one or more of the folds or flaps. The tri-fold section can be rolled up in a partial rectangle shape (three-sided) for insertion into a base, such as that shown in FIG. 29. This partial rectangular shape is what can allow in embodiments the void in the centre of the box (as described above) which can be used for insertion of additional items.

FIG. 18 is a skeleton line drawing (CAD) showing the box partially assembled. Here the node 1714 is shown inserted into the middle of three slots 1712 on the opposite arm, thereby using the medium arrangement of the adjustable retainer. One line of the box 1802 can be formed with additional perforations, for a hanging arrangement described below.

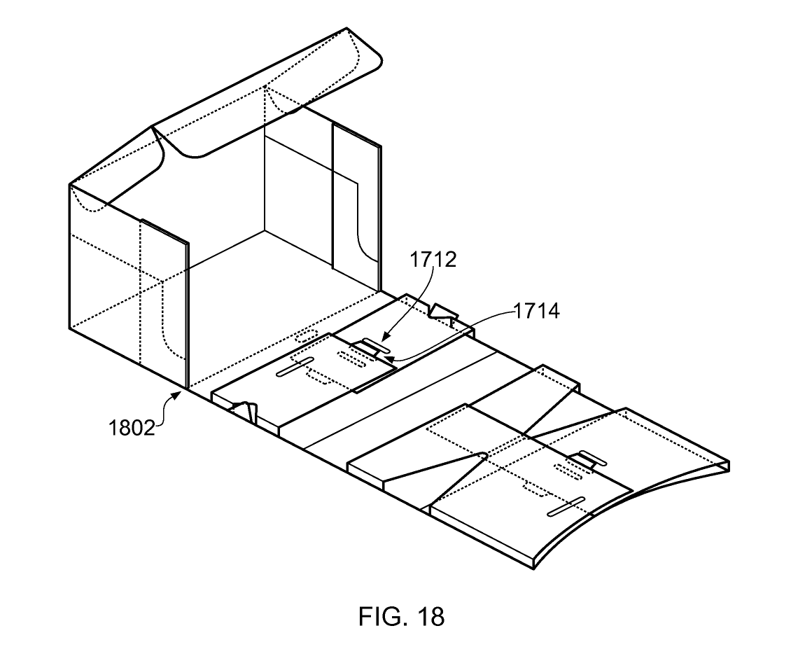

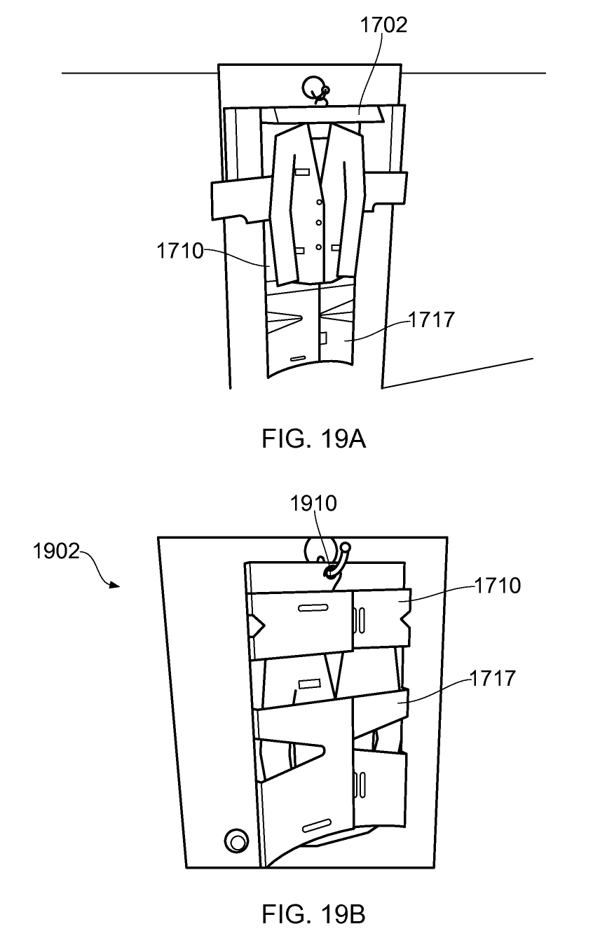

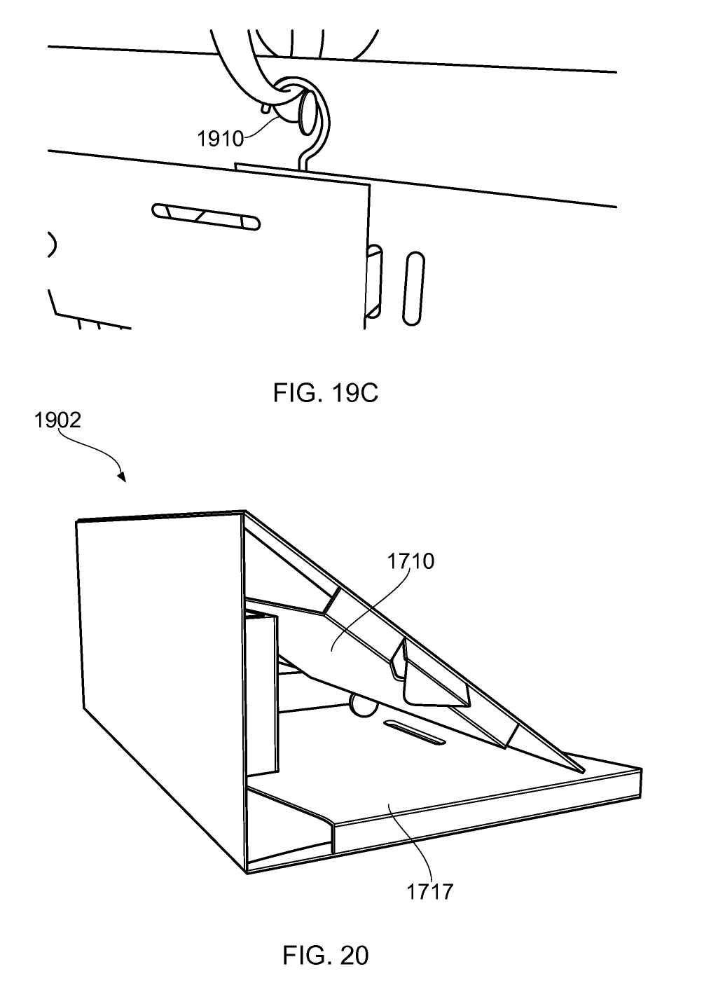

FIG. 19A shows the box in its additional use arrangement, opened out and hung for use as a wardrobe fixture or component. A hanger on which the garment is hung is passed through perforated handle holes in the ceiling panel 1702 of the box, and hung on a wardrobe or door hook. The ceiling panel then rests on the hung garment and acts as a dust cover.

In an alternative for the same box shown in FIG. 19B, a portion of the box 1902 can be detached from the remainder to use as a separate hanging arrangement. Perforations 1802 shown in FIG. 18 are used to separate the most distal panels from the rest of the box, and the perforations 1722 shown in FIG. 17 are used to expose a hole 1910 in the panel through which a hanger or hook can be inserted, on which the garment hanger can be hung. In this arrangement, the garment can be maintained in the retainers and hung up immediately, as shown in FIG. 19B.

FIG. 19C shows a close-up view of the hole or aperture 1910 through which the hook protrudes, for use by the hanger. As FIG. 20 illustrates, this detachable portion can itself be folded once used, for transport and unfolded for later reuse.

In an alternative, rather than the box and detachable portion being separated by a perforated section on the box, separation of the base (1702, 1704, 1706) and the detachable portion (1902) can be performed by unlocking a mechanism attaching the two portions. This allows the detachable portion to be attached and detached when necessary. For example, as noted above this allows flexibility in pick and packing operations, so that a detachable portion can be attached to one of a number of alternative bases, depending on the amount of clothing being packed. Alternatively, a base portion can be attached to one of a number of alternative detachable portions.

The mechanism can take a number of forms, for example locking/lockable tabs similar to those used to secure the box as described above (230, 250) can be used. Other known fixtures such as double side tape, Velcro (Trade Mark) and other fasteners can be used.

FIGS. 29a and 29b illustrate an example of a separate base to which the detachable portion (such as a tri-fold section) can be attached. FIG. 29a shows the unfolded blank, and FIG. 29b the assembled base. The protruding lip on the base can be used for mounting the detachable portion, incorporating a locking mechanism or part thereof as described above. The base can be in either of the 500 mm×300 mm×300 mm or 500 mm×300 mm×200 mm sizes as noted above.

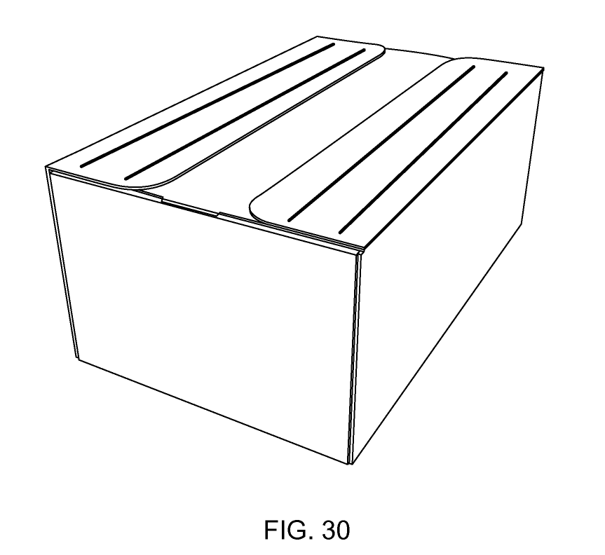

The flexibility allowed by the base and detachable portion is particularly advantageous in a factory distribution centre/fulfilment centre. As shown in FIG. 30 the goods are still able to be hung, but are half prepared for packaging to send. Most sophisticated fulfilment centres have automated racking systems, so that they identify the order as they go around; this is the same for dry cleaning operations. Embodiments of the invention can therefore be used to make sure operations more efficient—the garments can be part packed, providing protection initially and ease of assembly of the later box, and providing options for marking or tagging the detachable portion around the garments for identification.

Note that the lower/tri-fold/detachable portion of the box can be sold as a separate item, along with bases being sold separately, as different parts of the cleaning or collection or packing supply chain may only require certain portions.

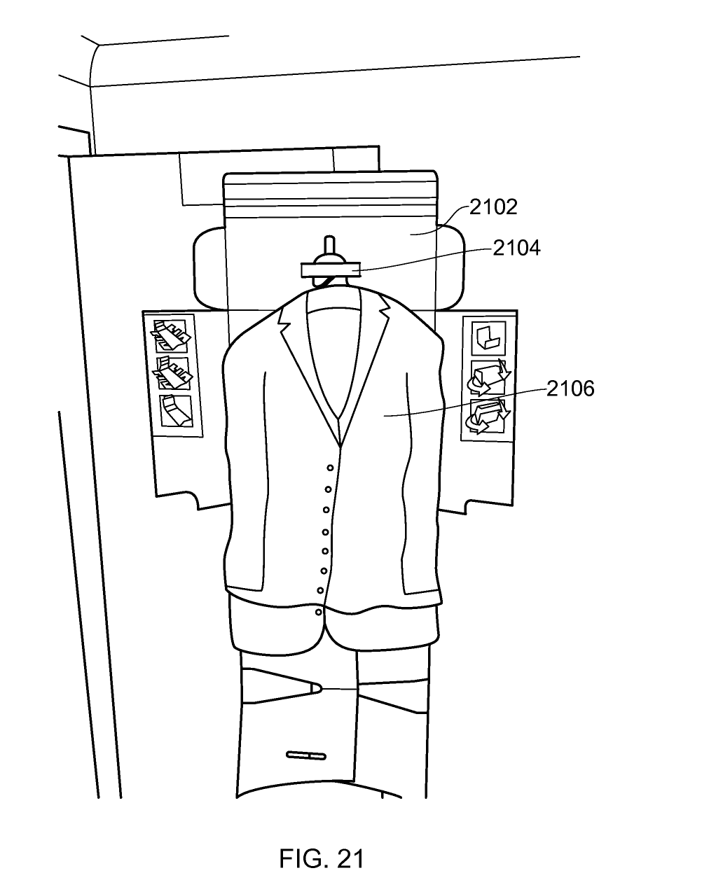

FIG. 21 shows a box similar to those shown in FIGS. 17 to 20, in an opened format in the wardrobe arrangement. The hanger 2102 is passed through the handle holes in the ceiling panel 2102 and hung on a hook. The garment 2106 here is shown removed from the retainers, protected by a dry cleaners' film protector. The reinforcement of the handle holes by tape or composite strap provides extra load-bearing for this wardrobe arrangement.

The box may contain additional fixtures or compartments, as shown in FIG. 21 on the side panels of the top section, for further items, such as tie pins, cufflinks, razors and the like. A vanity pack may be included as standard.

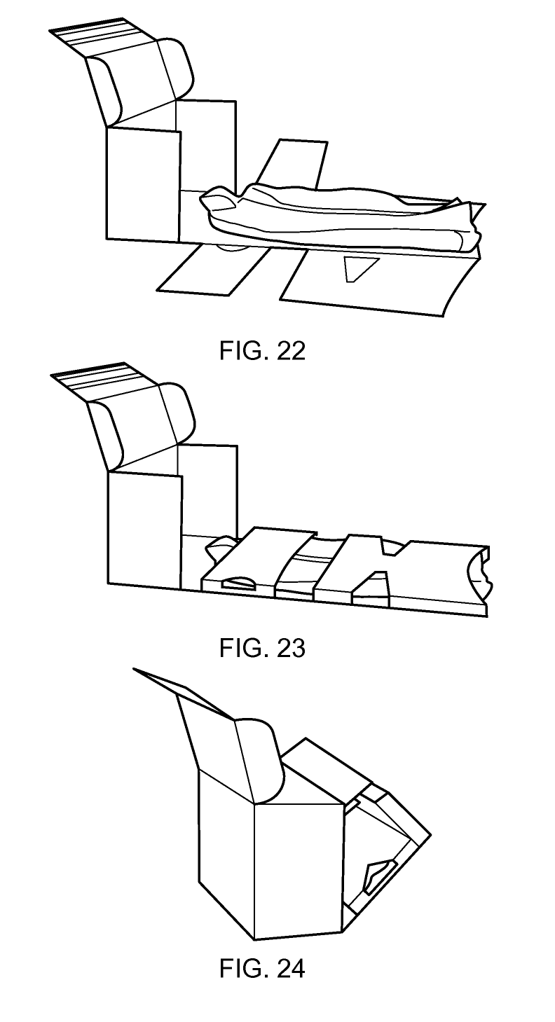

FIGS. 22, 23 and 24 illustrate an example of the folding of a garment, here a suit jacket, into a box according to these later embodiments. In FIG. 22, the jacket is laid on to the panels of the tri-fold section of the box. In FIG. 23, the retainers are deployed, in this case the upper retainer and the whale-fin retainer, to secure the jacket.

FIG. 24 illustrates the last step of the tri-folding action of the lower section—the tri-fold section folds up into a box-shaped section, which is then inserted into the box or base section, to complete the assembly.

As noted previously, and shown in FIG. 20, the tri-fold section can also be arranged as a triangular cross-section shape, for assembly into a base, or for packing separately. Note that, again as described above, the tri-fold section can perform any or all of the steps shown in FIGS. 22 to 24 while separated from a base section, so that the tri-fold section can be part-packed awaiting connection to a base section later for final assembly and packing.

It will be appreciated by those skilled in the art that the invention has been described by way of example only, and that a variety of alternative approaches may be adopted without departing from the scope of the invention.

For example, although reference has been made to the garment being placed in a box after it has been folded, it will be appreciated that a garment may be placed in a partially folded garment container.

In embodiments, the box or tri-fold or base is provided with an indent to indicate to the user where the garment should be placed on the panels for assembly. The indent can take the general shape of a garment, or be specifically in the shape of a garment, such as a jacket. Further indications, such as pictures illustrating a folding method, can be provided on the internal panels.

In one embodiment, a mirror is provided on the inside of one panel of the box, to assist the customer when using the box in an opened-out wardrobe arrangement. The mirror can be any sort of known surface for the purpose, such as a polished material, or a composite or plastic reflective surface.

Other variations to the invention may be made, for example by including accessory items of personal importance to users, such as toiletries and/or an overnight bag, for example of the type handed out by airlines, to passengers as a result of losing their luggage. In this sense the invention may be supplied as a kit of items—either as a male replacement wardrobe, with slacks or trousers, shirt, jacket and underwear as well as toiletries; or as a female replacement wardrobe, with slacks/skirt, blouse, jacket and underwear as well as female toiletries.

In one embodiment, a box containing a standard set of clothing and accessories is used as replacement luggage, for example as a lost luggage assistance pack at an airport or the like. The pack uses a box as in one of the above embodiments, packed with a standard set of clothing, such as a shirt and trousers, and accessories such as toothbrush and toothpaste, and razor. After use of the pack, the user can return the box for re-use having packed the clothes and accessories, whereupon the box can be returned via any of the channels described above, such as a click and collect network, for the clothes to be cleaned and the accessories to be replaced.

In another variation labels and identity devices may be supplied with the invention, and may include pre-paid postage or special pre-franked stamps/barcodes, so as to allow the user to mail clothing directly to a launderette or dry cleaning facility after having used the contents. This is felt to be of particular benefit to services personnel or to staff who are often travelling, so that they do not have to carry excess luggage and so that clean laundered clothing can be supplied ahead of meetings and waiting at a subsequent destination. The box is also of benefit to companies who offer suits (such as morning attire) and dresses as part of a hire services for example for weddings and special occasions; enabling providers of such services to supply all necessary garments to a specific location and for the garments to be returned for cleaning in readiness for future events.

1. A garment box comprising: a plurality of side wall panels, a ceiling panel and a floor panel; and at least one retainer for securing a garment.

2. A garment box according to claim 1, wherein the at least one retainer comprises a plurality of retainers.

3. A garment box according to claim 1 wherein the at least one retainer is arranged to cooperate with one of the panels of the box.

4. A garment box according to claim 2 wherein the plurality of retainers are each arranged to cooperate with a respective panel of the box.

5. A garment box according to claim 4, wherein the plurality of retainers are arranged to cooperate with respective adjacent panels.

6. A garment box according to claim 4 comprising at least three retainers, each of which is arranged to cooperate with a respective panel.

7. A garment box according to claim 6, wherein the three retainers are each arranged to retain one of three portions of a garment on the respective panel, on three adjacent panels of the box.

8. A garment box according to claim 1 wherein the at least one retainer comprises a planar portion, configured to counteract vertical forces on the garment. retainer comprises a planar portion, configured to counteract vertical forces on the garment.

9. A garment box according to claim 8, wherein the at least one retainer is arranged to cooperate with the ceiling panel or the floor panel of the box.

10. A garment box according to claim 9, wherein the planar portion is positionable parallel to the ceiling or floor panel for retaining the garment, thereby counteracting vertical forces on the garment.

11. A garment box according to claim 3 wherein the at least one retainer is coupled to the panel with which it is arranged to cooperate.

12. A garment box according to claim 11, wherein the at least one retainer is movable between a deployed retaining position and an opened position.

13. A garment box according to claim 12, wherein the at least one retainer is hinged on an edge of the panel.

14. A garment box according to claim 3 wherein the at least one retainer is configurable to retain the garment for securing by trapping the garment between the retainer and the panel with which it is arranged to cooperate.

15. A garment box according to claim 1 wherein the at least one retainer comprises an adjustable retainer.

16. A garment box according to claim 15, wherein the adjustable retainer comprises an adjuster portion for modifying the effective size of the adjustable retainer.

17. A garment box according to claim 16, wherein the effective size adjusted is a length of the retainer.

18. A garment box according to claim 16 wherein the effective size adjusted is a volume enclosed by the retainer and the panel with which it is arranged to cooperate.

19. A garment box according to claim 15 wherein the retainer comprises a set of two coupled retainer arms extending towards each other over the panel.

20. A garment box according to claim 19, wherein a first retainer arm comprises a set of notches, and a second retainer arm comprises a node for engaging one of the notches to couple the retainer arms, whereby movement of the node from one notch to another adjusts the effective size of the retainer.

21. A garment box according to claim 19 wherein the first retainer arm is hinged to a first edge of the panel, and the second retainer arm is hinged to a second, opposite edge of the panel.

22. A garment box according to claim 1 wherein a retainer is arranged to cooperate with two adjacent panels of the box.

23. A garment box according to claim 19 wherein a first retainer arm is hinged to first edges of each of the two adjacent panels, and a second retainer arm is hinged to second, opposite edges of each of the two adjacent panels.

24. A garment box according to claim 23, wherein the first retainer arm divides into two sub arms in the region of the hinges, a first sub-arm being hinged to the first edge of a first adjacent panel, and a second sub-arm being hinged to the first edge of a second adjacent panel.

25. A garment box according to claim 24, wherein the first retainer arm is folded to cooperate with the fold between the two adjacent panels.

26. A garment box according to claim 1 wherein the box is adapted as a standard size and shape permissible by international logistics networks.

27. A garment box according to claim 26 wherein the dimensions of the box are approximately 500 mm (wide) by 300 mm (deep) by 300 mm (high).

28. A garment box according to claim 26 wherein the dimensions of the box are approximately 500 mm (wide) by 300 mm (deep) by 200 mm (high).

29. A garment box according to claim 1 wherein an internal portion of the box comprises a fixture for securing smaller garments.

30. A garment box according to claim 1 wherein the at least one retainer comprises a supporter for holding items within the container.

31. (canceled)

32. A garment box according to claim 31 wherein the supporter is a hanger.

33. A garment box according to claim 32 wherein the hanger is integral to the box.

34. A garment box according to claim 32 wherein at least a portion of the hanger is detachable from the box.

35. A garment box according to claim 34 wherein a border between the detachable portion and the remainder of the hanger is defined by perforations.

36. A garment box according to claim 1 wherein the box comprises lockable tabs, the box being closable using the tabs.

37. A garment box according to claim 36 further comprising a cut out providing a finger hold for opening the lockable tabs.

38. A garment box according to claim 36 further comprising a sticker for opening and re-sealing the box.

39. A garment box according to claim 1 further comprising a tracking Radio Frequency Identification (RFID) or barcode label.

40. A garment box according to claim 1 wherein the ceiling panel comprises a handle portion.

41. A garment box according to claim 40 wherein the ceiling panel comprises strengthening tape, through which perforations are made to form the handle portion.

42. A garment box according to claim 1 wherein the box is adapted to be assembled by folding from a sheet blank.

43. A garment box according to claim 1 further comprising additional panels, the additional panels foldable into the box on assembly.

44. A garment box according to claim 42 wherein the sheet blank comprises:
one of: the side wall; ceiling; or floor panels having four other panels coupled to four respective edges said one of the panels; and
at least one further panel coupled to an outer edge of one of said other panels.

45. A garment box according to claim 44 wherein a furthest panel from said one of the panels comprises a curved outermost edge, configurable on assembly to straddle a garment contained by the box.

46. A garment box according to claim 1 wherein the at least one retainer and garment are arranged around the periphery of an internal space of the box defined by the panels, and at least one of the retainer or a panel configured to accommodate an additional garment or item in the internal space defined.

47. A garment box according to claim 1 wherein the box is adapted to be unfolded for use as a hanging wardrobe for the garment.

48. A garment box according to any claim 1 wherein the box comprises a detachable portion for use as a hanging wardrobe for the garment.

49. A garment box according to claim 1 wherein three distal adjacent panels and associated retainers of the box are arranged to be foldable into a tri-fold element, for assembly into the box.

50. A garment box according to claim 49 wherein the detachable portion comprises a plurality of the panels of the box, and at least one retainer.

51. A method of folding a garment within a box according to claim 1 comprising:
a. placing the item of clothing into or onto an internal surface of the box; and
b. placing the at least one retainer in contact with the garment to retain a position without creasing.

52. A method according to claim 51 further comprising wrapping a tri-fold element of the garment box around a hanging garment to retain position without creasing and ensure goods are ready for final assembly and packaging for fulfilment.

53. A method according to claim 52 further comprising folding the box containing the item of clothing into a final assembled shape.

54. A method according to claim 53 further comprising placing the garment on a hanger; and securing a hook of the hanger to a fastener of the garment box.

55. A drop and collect cleaning system comprising:
a. placing at least one garment to be cleaned in a garment box according to claim 1;
b. dropping off the garment box at a drop off location; and
c. collecting a cleaned garment in a garment box from a pre-arranged collection location.

56. A system as claimed in claim 55 further comprising: tracking the garment through the cleaning process.

57. A drop and collect cleaning system comprising:
placing at least one garment to be cleaned in a garment box according to claim 1;
dropping off the garment box at a drop off location; and
delivering a cleaned garment in a garment box to a pre-arranged collection location.

58. A system as claimed in claim 57 further comprising tracking the garment box from a first location to a second location.

59. A system as claimed in claim 55 wherein the drop off location is a parcel shop or intelligent parcel locker.

60. A system as claimed in claim 55 comprising a click and collect system.

61. A user selectable purchase and delivery service, including the steps of: selecting from a menu an article of clothing/footwear; specifying a size for the article of clothing/footwear; specifying a delivery address and providing information sufficient to complete the purchase, whereby the article of clothing/footwear is packaged in a garment box according to claim 1.
